(19) United States
(12) Patent Application Publication
(10) Pub. No.: US 2021/0192951 A1
(43) Pub. Date: Jun. 24, 2021

(54) SYSTEM, VEHICLE CONTROL DEVICE, AND METHOD

(71) Applicant: HONDA MOTOR CO., LTD., Tokyo (JP)

(72) Inventor: Koichi Ogura, Tokyo (JP)

(21) Appl. No.: 17/124,528

(22) Filed: Dec. 17, 2020

(30) Foreign Application Priority Data
Dec. 20, 2019 (JP) 2019-230300
Dec. 20, 2019 (JP) 2019-230301

(51) Int. Cl. G08G 1/127; G01C 21/34; G08G 1/14; E05F 15/70; G06Q 10/10; G06Q 10/06; G06Q 20/08; G06Q 30/02; G06Q 50/30; G06Q 10/02; G06Q 20/40

(52) U.S. Cl. CPC G08G 1/127; G01C 21/343; G08G 1/141; E05F 15/70; G06Q 10/10; G06F 3/14; G06Q 20/085; G06Q 30/0284; G06Q 50/30; G06Q 10/02; G06Q 20/407; G06Q 10/06315

(57) ABSTRACT

A system includes a first acquirer configured to acquire first notification information for applying for use of a vehicle from a terminal device of a user, a first processor configured to perform securing processing for securing a vehicle to be provided to the user, in accordance with the first notification information acquired by the first acquirer, and a second processor configured to perform processing based on a change in details of use of the vehicle in a case where the details of use of the vehicle have been changed after the first acquirer acquires the first notification information.

### CROSS-REFERENCE TO RELATED APPLICATION

The application is based on Japanese Patent Application No. 2019-230300 filed on Dec. 20, 2019 and Japanese Patent Application No. 2019-230301 filed on Dec. 20, 2019, the content of which incorporated herein by reference.

### BACKGROUND

### Field of the Invention

The present invention relates to a system, a vehicle control device, and a method.

### Description of Related Art

In the related art, a scheduling method for calculating an alteration fee charged to a customer using the details of an original use request, the details of change of the use request, the date and time when the change was made, the date and time when a ride-sharing vehicle operation schedule was in operation, the number of times of change has been performed by the customer, and the like as functions in a case where a customer has required to a use request in the ride-sharing vehicle operation service is disclosed (for example, Japanese Unexamined Patent Application, First Publication No. 2003-141219). Further, in the related art, a technique for causing an on-vehicle device to detect a user and move an allocated vehicle to the location of the user in a vehicle allocation system including a vehicle allocation center allocating vehicles and an on-vehicle device and causing the allocated vehicle to travel to a place where the vehicle can be parked and meet the user in a case where a parking-allowable region for the allocated vehicle has been disturbed due to the presence of a vehicle parked on a road at the location of the user is disclosed (for example, Japanese Unexamined Patent Application, First Publication No. 2019-28663).

### SUMMARY

However, in the above-described scheduling method, a specific method of calculating an alteration fee is not disclosed, and there is a possibility that a user and an allocated vehicle will not be able to smoothly meet in a case where the area around the user is congested. That is, the above-described techniques do not have sufficient convenience for users.

The present invention is contrived in view of the above-described circumstances, and one of objects thereof is to provide a system, a vehicle control device, and a method which are capable of improving user convenience

The system, the vehicle control device, and the method according to the present invention adopt the following configurations.

(1) A system according to an aspect of the present invention is a system including: a first acquirer configured to acquire, from a terminal device of a user, first notification information for applying for use of a vehicle; a first processor configured to perform securing processing for securing a vehicle to be provided to the user, in accordance with the first notification information acquired by the first acquirer; and a second processor configured to perform processing based on a change in details of use of the vehicle in a case where the details of use of the vehicle have been changed after the first acquirer acquires the first notification information.

(2) In the aspect of (1), the system further includes a second acquirer configured to acquire, from the terminal device of the user, second notification information indicating that the details of the use have been changed, in which the second processor executes, as processing according to the change, processing for charging the user a first fee in a case where the second acquirer acquires second notification information in a first period, the first period being set to be a period between a timing at which the first acquirer acquires the first notification information and a timing at which the first processor transmits the securing notification information on the securing processing to the terminal device of the user.

(3) In the aspect of (2), the second processor charges the terminal device of the user a second fee higher than the first fee in a case where the second acquirer does not acquire the second notification information in the first period and acquires the second notification information in a second period which starts after the first period and ends when the vehicle secured by the first processor starts to move.

(4) In the aspect of (3), the second processor charges the terminal device of the user a third fee higher than the second fee in a case where the second acquirer does not acquire the second notification information in the first period and the second period, and acquires the second notification information in a third period which starts after the second period and ends when the user boards the vehicle.

(5) In the aspect of (4), the third fee is lower than an amount of money charged in a case where the user actually uses the vehicle.

(6) In the aspect of (2), the first processor performs processing for securing the vehicle after the securing notification information is transmitted to the terminal device.

(7) In the aspect of (2), the second processor subtracts the first fee from a deposit provided to the information processing device at least before the first processor performs the securing.

(8) In the aspect of (2), the first processor does not perform securing processing for securing a vehicle based on the first notification information transmitted by a terminal device of a user who has been charged a predetermined number of times or more or a predetermined amount of money or more by the second processor.

(9) In the aspect of (2), the first processor determines a first travel route of the vehicle based on the first notification information acquired from a first terminal device of a first user, and corrects the first travel route based on the first notification information acquired from a second terminal device of a second user in a case where the vehicle is traveling on the determined first travel route, and the first period is a period between a timing at which the first processor acquires first notification information of the second terminal device and a timing at which the first processor corrects the first travel route, and the second processor charges the second terminal device of the second user a fourth fee in a case where the second acquirer acquires the second notification information from the second terminal device in the first period.

(10) In the aspect of (9), the second processor charges the terminal device of the user a fifth fee higher than the fourth fee in a case where the second acquirer does not acquire the second notification information in the first period and acquires the second notification information in a second period between a timing at which the first processor corrects the first travel route and a timing at which the vehicle enters the corrected first travel route.

(11) In the aspect of (2), the first processor changes the first period, which is a period until the securing notification information is transmitted, based on an operation state of a vehicle managed by the information processing device to provide a service, and the second processor determines an amount of the first fee based on a length of the first period.

(12) In the aspect of (11), the first processor provides information indicating the first period to the terminal device and transmits the securing notification information to the terminal device in a case where information indicating acceptance of the first period is acquired from the terminal device.

(13) In the aspect of (1), the system further includes a second acquirer configured to acquire information on surrounding circumstances of a vehicle; a vehicle allocation controller configured to cause the vehicle to move to an expected meeting place designated by the user based on the first notification information; a charging controller configured to charge the user a vehicle allocation service charge based on an acquisition result of the first acquirer; and a vehicle stopping space determiner configured to determine whether or not there is a vehicle stopping space for parking the vehicle in the expected meeting place in a case where the vehicle allocated based on the first notification information has approached the expected meeting place, and the second processor proposes an alternative meeting place, which is different from the expected meeting place, to the user in a case where the vehicle stopping space determiner determines that there is no vehicle stopping space.

(14) In the aspect of (13), the first acquirer receives, from the user, a response including information regarding whether or not to change from the expected meeting place to the alternative meeting place in a case where the second processor proposes the alternative meeting place, and the charging controller does not charge the user a cancellation charge in a case where the first acquirer has received a response indicating that the alternative meeting place has been rejected and cancelled.

(15) In the aspect of (13), the second processor proposes the alternative meeting place to the user and then proposes to the user that a meeting place be set to the expected meeting place again from the alternative meeting place in a case where the second acquirer has acquired information indicating that there is a vehicle stopping space for parking the vehicle in the expected meeting place.

(16) In the aspect of (15), the first acquirer receives a response indicating a change to the alternative meeting place, a response indicating that the alternative meeting place is rejected to cancel vehicle allocation, or a response indicating a return to the expected meeting place in a case where the second processor has proposed to the user that a meeting place is set from the alternative meeting place to the expected meeting place, and the charging controller does not charge the user an additional charge in a case where any of the responses has been selected.

(17) In the aspect of (13), the system further includes a collector configured to collect determination results related to the expected meeting place and the alternative meeting place, which are obtained by the vehicle stopping space determiner, and the charging controller changes a charging rate for the expected meeting place based on an availability trend of vehicle stopping spaces with reference to results collected by the collector.

(18) In the aspect of (13), the second acquirer acquires recognition results of the surrounding circumstances of other vehicles other than the vehicle caused to move to the expected meeting place, and the vehicle stopping space determiner determines whether or not there is a vehicle stopping space based on the results of recognizing the surrounding circumstances of the other vehicles, in addition to results of recognizing the surrounding circumstances of the vehicle.

(19) In the aspect of (13), the vehicle allocation controller causes the vehicle to move to the alternative meeting place in a case where the first acquirer has received, from the user, a response indicating that the expected meeting place is to be changed to the alternative meeting place, and estimates that there is a vehicle stopping space for parking the vehicle in the expected meeting place and causes the vehicle to move to the expected meeting place in a case where the first acquirer has received, from the user, a response indicating that the expected meeting place is not to be changed to the alternative meeting place.

(20) In the aspect of (19), after the second processor proposes the alternative meeting place, the vehicle stopping space determiner performs processing for determining whether or not there is the vehicle stopping space in the expected meeting place until the vehicle arrives at the expected meeting place or the alternative meeting place, and the second processor cancels a change to the alternative meeting place and gives such a notification that a meeting place is able to be set to the expected meeting place again in a case where the alternative meeting place has been already proposed and the vehicle stopping space determiner determines that there is the vehicle stopping space in the expected meeting place.

(21) A vehicle control device according to an aspect of the present invention is a vehicle control device including a travel controller that controls traveling of an allocated vehicle in response to a vehicle allocation instruction of the system according to (13); and a door open and close controller configured to control opening and closing of a door of the allocated vehicle based on an instruction received from the user, in which, in a case where the first acquirer has accepted, from the user, to perform a pre-stop door open operation of starting to open the door even when the allocated vehicle has not completely stopped, the door open and close controller performs control so as to perform the pre-stop door open operation when the allocated vehicle has approached the meeting place within a predetermined distance and the allocated vehicle satisfies predetermined door open conditions.

(22) In the aspect of (21), the predetermined door open conditions include: a surrounding environment condition including a condition that the pre-stop door open operation is permitted in the meeting place; an allocated-vehicle-side condition including a condition that there is no object inside the allocated vehicle, which is likely to fall due to door opening; and a user-side condition including a condition that an amount of the user's luggage is less than a predetermined amount.

(23) In the aspect of (21), the door open and close controller stops opening of a door in a case where the predetermined door open conditions are not satisfied.

(24) An information processing method according to an aspect of the present invention is an information processing method, which is executed by a computer, the information processing method comprising: acquiring, from a terminal device of a user, first notification information for applying for use of a vehicle; performing securing processing for securing a vehicle to be provided to the user, in accordance with the first notification information acquired by the first acquirer; and performing processing based on a change in details of use of the vehicle in a case where the details of use of the vehicle have been changed after the first acquirer acquires the first notification information.

According to the above-described configurations of (1) and (24), it is possible to improve user convenience.

According to the aspects of (2), and (9) to (14), the information processing device charges the terminal device of the user the first fee in a case where the second notification information is acquired in the first period, and thus the user can consider whether or not to change the details of use after understanding a timing when the first fee is charged. In addition, it can be assumed that the user will be dissuaded from carelessly changing the details of use, and thus a processing load on a service provider will be reduced. Further, when the amount of details of use is reduced, the service provider can more effectively provide a service.

According to the aspects of (3) to (5), it is possible to reduce a change in the details of use in a case where a plan for providing a service is advanced to a certain degree.

According to the aspect of (6), the service provider actually secures a vehicle after a fee is generated, and thus it is possible to obtain compensation for the generated plan.

According to the aspect of (7), it is possible to more reliably obtain a fee. In addition, the user changes the details of use after providing the deposit, and thus a high level of satisfaction is obtained even when the fee is subtracted from the deposit.

According to the aspect of (8), it is possible to provide a service to a user who is unlikely to change the details of a reservation in preference to a user who is likely to change the details of a reservation.

According to the aspects of (13) to (23), it is possible to make the user and the allocated vehicle meet each other more smoothly.

According to the aspects of (21) to (23), it is possible to reduce a period of time until the user boards the allocated vehicle.

### BRIEF DESCRIPTION OF THE DRAWINGS

FIG. 1 is a diagram illustrating an example of a configuration of a vehicle system using an information processing device.

FIG. 2 is a diagram illustrating an outline of processing executed by the vehicle system.

FIG. 3 is a diagram illustrating an example of a functional configuration of a management device.

FIG. 4 is a sequence diagram illustrating an example of a flow of processing executed by the vehicle system.

FIG. 5 is a diagram illustrating processing for generating a reservation schedule.

FIG. 6 is a diagram illustrating an example of the details of vehicle information.

FIG. 7 is a sequence diagram illustrating an example of a flow of processing from when a vehicle starts to move to when a user boards the vehicle.

FIG. 8 is a diagram illustrating an example of the details of status information generated by a manager through the above-described processing of FIGS. 4 and 7.

FIG. 9 is a flowchart illustrating an example of a flow of charging processing performed by an information processor.

FIG. 10 is a diagram illustrating an example of charging information used to describe determination of a charging amount.

FIG. 11 is a diagram illustrating an example of the details of totalization information.

FIG. 12 is a flowchart illustrating an example of a flow of processing executed by an information processor according to a second embodiment.

FIG. 13 is a diagram illustrating an example of the details of totalization information according to the second embodiment.

FIG. 14 is a diagram illustrating processing in which an acquired reservation request is incorporated into a reservation schedule.

FIG. 15 is a sequence diagram illustrating an example of a flow of processing executed by a vehicle system according to a fourth embodiment.

FIG. 16 is a diagram illustrating processing in a case where a reservation is cancelled.

FIG. 17 is a diagram (Part 1) illustrating processing executed by a management device according to a fifth embodiment.

FIG. 18 is a diagram (Part 2) illustrating processing executed by the management device according to the fifth embodiment.

FIG. 19 is a configuration diagram of a vehicle allocation system.

FIG. 20 is a configuration diagram of a vehicle allocation device.

FIG. 21 illustrates an example of information stored in vehicle stopping space information.

FIG. 22 illustrates an example of information stored in vehicle information.

FIG. 23 is a diagram illustrating an example of an image displayed on a terminal device when a vehicle allocation request is made.

FIG. 24 is a diagram illustrating an example of an image displayed on a terminal device when a vehicle allocation request is received.

FIG. 25 is a diagram illustrating a first scene.

FIG. 26 is a diagram illustrating a second scene.

FIG. 27 is a diagram illustrating an example of an image displayed on a terminal device with regard to the details of a proposal made by a proposer.

FIG. 28 is a diagram illustrating an example of an image displayed on the terminal device with regard to the details of a proposal made by the proposer.

FIG. 29 is a diagram illustrating collecting processing performed by a collector.

FIG. 30 is a flowchart illustrating an example of a flow of vehicle allocation processing performed by a vehicle allocation system.

FIG. 31 is a flowchart illustrating an example of a flow of processing for designating an expected meeting place which is performed by the vehicle allocation device.

FIG. 32 is a diagram illustrating an example of an image displayed on a terminal device when a vehicle allocation request including a request for pre-stop door opening is made.

FIG. 33 is a diagram illustrating a third scene.

FIG. 34 is a diagram illustrating the third scene.

FIG. 35 is a diagram illustrating the third scene.

FIG. 36 is a flowchart illustrating another example of a flow of processing for designating an expected meeting place which is performed by the vehicle allocation device.

FIG. 37 is a flowchart illustrating an example of a flow of pre-stop door open operation processing which is performed by a door open and close controller.

FIG. 38 is a diagram illustrating an example of a hardware configuration of the vehicle allocation device according to the embodiment.

### DESCRIPTION OF EMBODIMENTS

Hereinafter, embodiments of a system, a vehicle control device, and a method of the present invention will be described with reference to the accompanying drawings.

<First Embodiment>

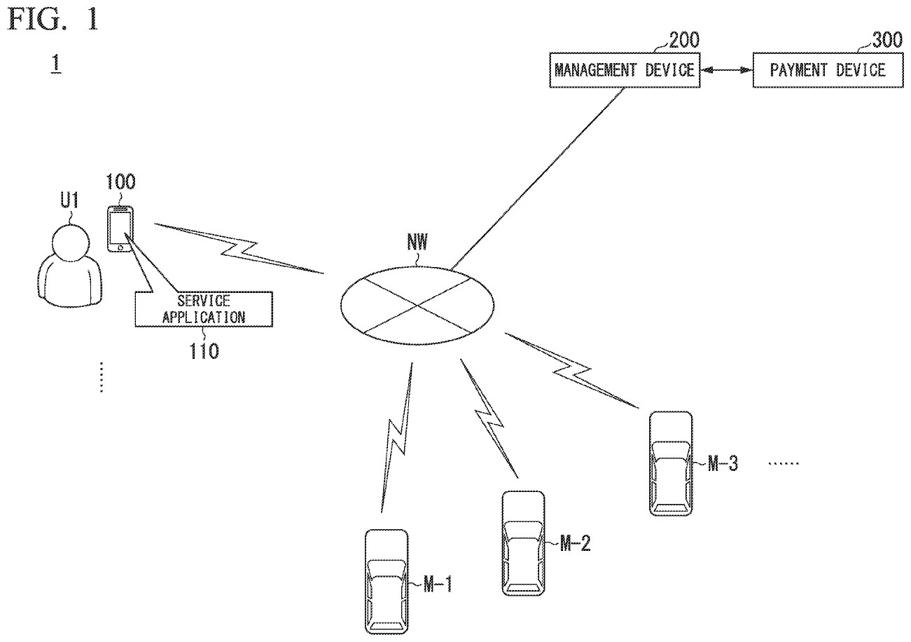

FIG. 1 is a diagram illustrating an example of a configuration of a vehicle system 1 using an information processing device. The vehicle system 1 is a system that provides a vehicle service to a user in response to a user's request, the vehicle service being a service for providing a vehicle to a user. A vehicle is automatically driven to take a user to a destination or is manually driven. In the case of manual driving, a driver drives to cause a vehicle to travel and move to a boarding location of a user. Further, the vehicle system 1 provides a payment service related to the use of a vehicle to a user.

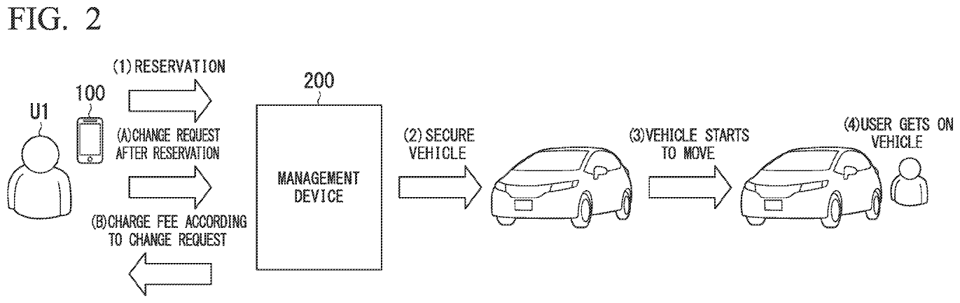

The vehicle system 1 includes, for example, one or more vehicles M (in the drawing, vehicles M-1 to M-3 . . . ), one or more terminal devices 100, a management device 200, and a payment device 300. The vehicles M, the terminal devices 100, and the management device 200 communicate with each other through, for example, a network NW. The network NW includes, for example, a cellular network, a Wi-Fi network, Bluetooth (registered trademark), the Internet, a wide area network (WAN), a LAN, a public line, a provider device, a dedicated line, a wireless base station, and the like. The management device 200 is an example of an “information providing device”.

[Outline of Vehicle Service]FIG. 2 is a diagram illustrating an outline of processing executed by the vehicle system 1. First, when a user operates the terminal device 100 to transmit a reservation request related to the use of a vehicle service to the management device 200 (1), the management device 200 secures a vehicle M to be used for the vehicle service (2). Next, the vehicle M starts to move in accordance with the time when the use of the vehicle service will be started (3). Next, the vehicle M arrives at the user's boarding location, and the user can board the vehicle M (4). Then, the user can head for a destination using the vehicle M on which the user has boarded.

In the above-described processing, when the management device 200 acquires a request related to a change related to the reservation (A) after the user has made the above-described reservation of (1), the management device charges the terminal device 100 of the user a fee in accordance with a timing at which the management device acquires the request (B).

[Vehicle]

The vehicle M may be, for example, a vehicle with four or more wheels which one or more users can board, but may be a motorcycle or any of other vehicles. The vehicle M includes equipment providing a vehicle service other than a driving force output device for controlling the vehicle, a brake device, a steering device, and a control device.

The vehicle M is, for example, an automatic driving vehicle. The automatic driving vehicle is a vehicle that travels automatically to a destination by controlling steering and acceleration/deacceleration independently of an operation of an occupant of the vehicle M. The automatic driving vehicle recognizes an object in the vicinity of the vehicle M based on, for example, an image captured by a camera, detection results of a radar device, detection results of light detection and ranging (LIDAR) device, and the like. The automatic driving vehicle travels toward a destination based on recognition results with respect to objects, the location of the vehicle M, and map information stored in a storage device.

[Terminal Device]The terminal device 100 is a terminal device which is held by a user who uses a vehicle service. The terminal device 100 is a terminal device that can be carried by a user, such as a smartphone, a tablet terminal, or a personal computer. In the terminal device 100, various functions are realized by executing an application program (software) stored in a storage device by a processor such as a central processor (CPU).

The application program may be a browser or may be a program having more extended functions than the browser, such as a so-called smartphone application. In the following description, the terminal device 100 is a smartphone and is based on the assumption that a service application 110 installed in the terminal device 100 in advance is used in processing related to a vehicle service. The service application 110 communicates with the management device 200 in response to a user's operation, and transmits the user's request to the management device 200 or gives a push notification based on information received from the management device 200.

[Management Device]

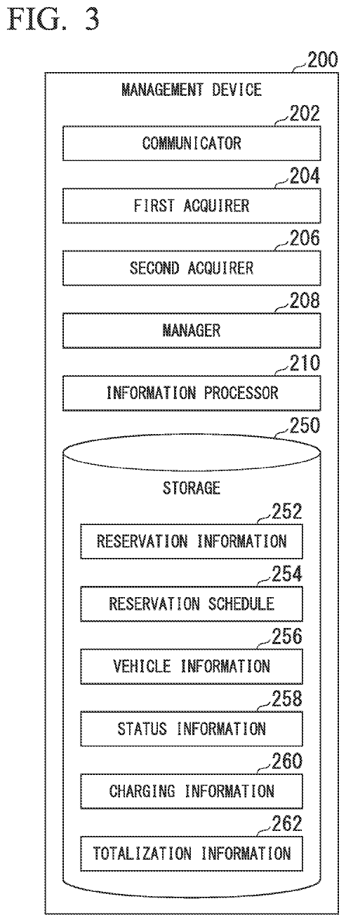

FIG. 3 is a diagram illustrating an example of a functional configuration of the management device 200. The management device 200 includes, for example, a communicator 202, a first acquirer 204, a second acquirer 206, a manager 208, an information processor 210, and a storage 250. The first acquirer 204, the second acquirer 206, the manager 208, and the information processor 210 are realized by executing programs (software) stored in a storage device by a processor such as a CPU. Some or all of these functional units may be realized by hardware such as a large scale integration (LSI), an application specific integrated circuit (ASIC), or a field-programmable gate array (FPGA), or may be realized by software and hardware in cooperation.

In the storage 250, for example, reservation information 252, a reservation schedule 254, vehicle information 256, status information 258, charging information 260, and totalization information 262 are stored.

The communicator 202 is a communication interface for communicating with other devices through the network NW. The communicator 202 receives, for example, a reservation request from the terminal device 100. The reservation request is a request for requiring use of a vehicle service.

The first acquirer 204 acquires a use request (first notification information) for applying for use of the vehicle M through the communicator 202 from the terminal device 100 of the user. The second acquirer 206 acquires second notification information indicating that the details of use (the details of the use request) have through the communicator 202 from the terminal device 100 of the user. The “change” refers to cancellation of a reservation or change of the details of a reservation.

The manager 208 performs processing related to management of a reservation for a vehicle service in response to the acquisition of the first notification information by the first acquirer 204. The management of the reservation refers to reception of the reservation, confirmation regarding whether or not the details of the received reservation overlap the details of other reservations, or securing of a vehicle corresponding to the reservation. The manager 208 is an example of a “first processor”.

The information processor 210 charges the terminal device 100 of the user a first fee in accordance with a timing at which the second acquirer 206 acquires the second notification information. The charging refers to requesting of a charge, for example, from the payment device 300 to collect the charge from the user. The information processor 210 is an example of a “second processor”.

[Payment Device]

The payment device 300 is a device that allows payment related to a cancellation charge and a fee for a reservation of a vehicle service and a usage charge for the vehicle service in response to a request of the management device 200. The payment device 300 performs payment using a predetermined payment method. The payment method is, for example, payment using a credit card. In addition, the payment method may be any payment method such as payment based on electronic money, payment based on bank transfer, or payment using a bill for paying a use fee at a designated place.

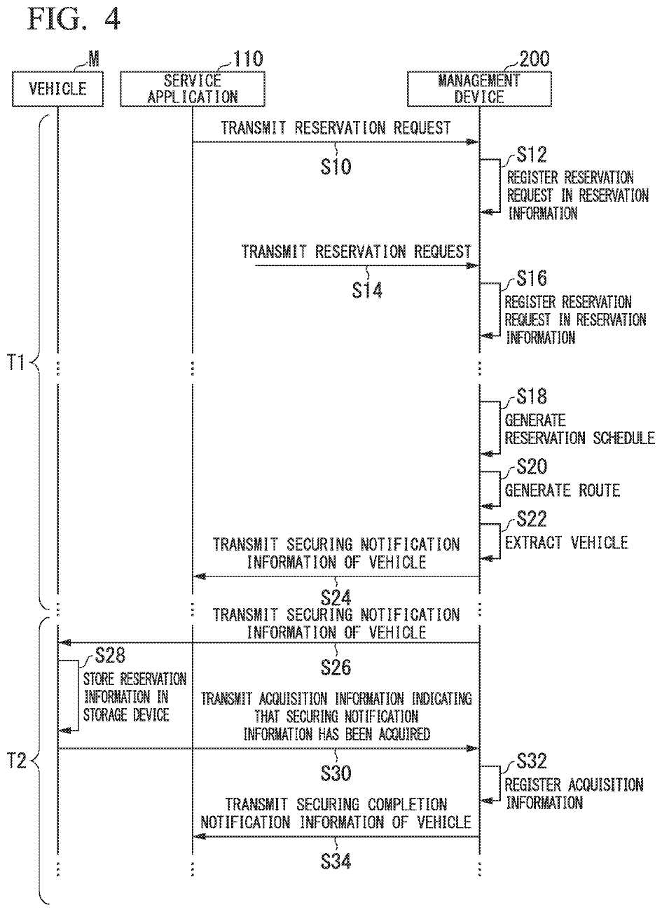

FIG. 4 is a sequence diagram illustrating an example of a flow of processing executed by the vehicle system 1. First, the service application 110 of the terminal device 100 transmits a reservation request to the management device 200 (step S10). When the first acquirer 204 of the management device 200 acquires a reservation request, the manager 208 registers the reservation request in the reservation information 252 (step S12). The reservation information 252 is information including one or more reservation requests. Further, when a service application 110 installed in another terminal device 100 transmits a reservation request to the management device 200, the manager 208 acquires the reservation request (step S14) and registers the acquired reservation request in the reservation information 252 (step S16).

The manager 208 repeatedly generates the reservation schedule 254 (step S18). The manager 208 generates the reservation schedule 254, for example, at predetermined time intervals. Alternatively, the manager 208 may generate the reservation schedule 254 in a case where a predetermined condition is satisfied. The predetermined condition is that a number of reservation requests transmitted by a predetermined number of service applications 110 are registered in the reservation information 252.

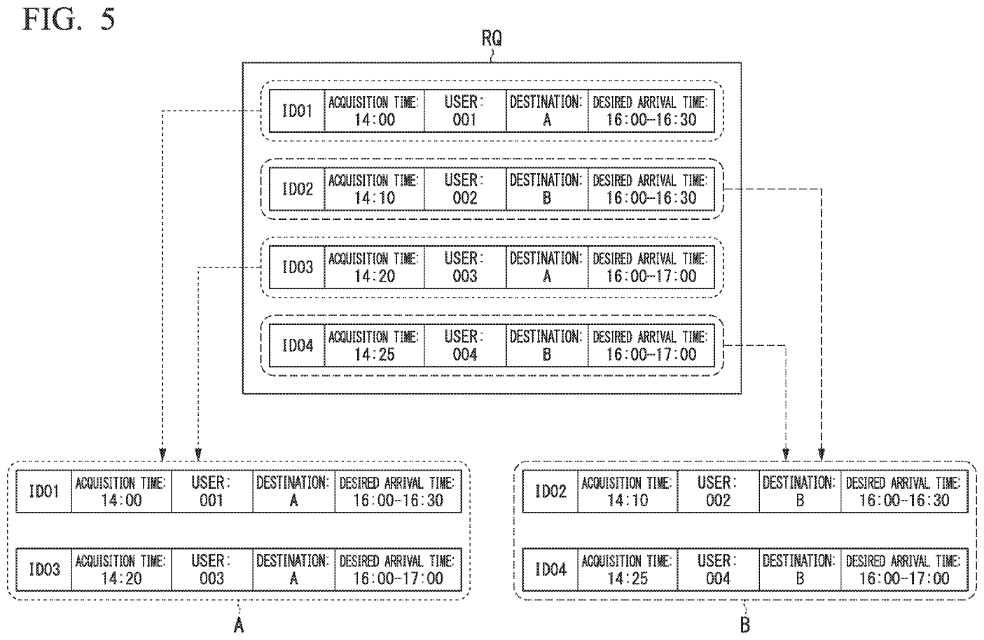

FIG. 5 is a diagram illustrating processing for generating a reservation schedule. The manager 208 groups one or more reservation requests RQ acquired from the terminal device 100 on the assumption that, for example, a plurality of users are caused to board one vehicle or a vehicle is caused to be continuously used in the same area. The reservation request RQ is information in which the time when the reservation request RQ was acquired, identification information (user ID) of a user, a destination of the user, and the time when arrival at the destination is desired are associated with identification information (ID) of the reservation request.

The manager 208 groups reservation requests so as to reduce the operation cost of a vehicle in a case where a plurality of persons board the vehicle, as compared with the total operation cost for each vehicle in a case where one vehicle is provided to each person. For example, the manager 208 comprehensively combines and groups reservation requests at predetermined time intervals and obtains costs in a case where a user included in the group boards a vehicle for each group. Then, the management device 200 determines a combination of users for minimizing the sum of costs obtained for each group to be a group.

However, the manager 208 determines a group to be adopted so that a group having a cost equal to or greater than a threshold value is not generated among the groups. In the example of FIG. 5, a group A including a reservation request ID01 and a reservation request ID03 and a group B including a reservation request ID02 and a reservation request ID04 are determined as groups in accordance with the above-described standards.

Description will return to FIG. 4. Next, the manager 208 generates a route of a vehicle based on a reservation schedule (step S20). For example, the manager 208 generates a route for efficiently picking up users included in a group and efficiently taking each user to a destination. For example, the route is generated based on a Dijkstra's method.

Next, the manager 208 of the management device 200 extracts a vehicle to be allocated for each group with reference to the generated route and the vehicle information 256 (step S22).

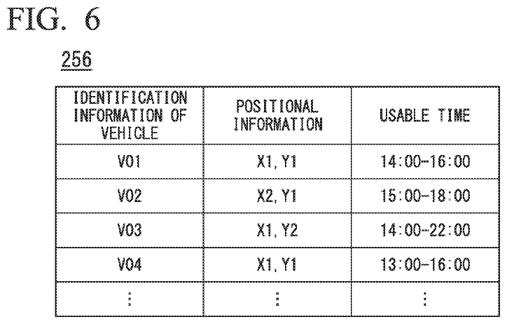

FIG. 6 is a diagram illustrating an example of the details of the vehicle information 256. The vehicle information 256 is information in which positional information and a time slot (usable time) in which the vehicle can be used are associated with identification information of the vehicle. The manager 208 is positioned, for example, near a departure point of the generated route, and extracts a vehicle that can be used in a time slot including a time required to take a user to a destination and a time required to return the vehicle from the vehicle information 256.

Next, when the manager 208 extracts the vehicle, the manager transmits first securing notification information of the vehicle to the vehicle M (step S24). Next, the management device 200 waits for a predetermined period of time from the process of step S24 and then transmits second securing notification information to the vehicle M (step S26). The process in which the manager 208 transmits the second securing notification information to the vehicle M is an example of “securing processing”.

The predetermined period of time may be several minutes or several tens of minutes. For example, even when a reservation request is transmitted due to a user's operation error or the user's desire has changed, the management device 200 can stop processing related to the reservation request before actually securing the vehicle M by waiting for a predetermined period of time before actually securing the vehicle.

When the vehicle M acquires the second securing notification information, the vehicle stores information included in the second securing notification information in a storage device of the vehicle M (step S28). In the storage device, identification information of a user who boards the vehicle M, a location where the user boards the vehicle M, a destination of the user, a route of the vehicle M (reservation information), and the like are stored. Next, the vehicle M transmits acquisition information indicating that the second securing notification information has been acquired to the management device 200 (step S30). When the management device 200 acquires the acquisition information, the management device stores the acquisition information in the storage 250 (step S32). Next, the management device 200 transmits securing completion notification information indicating that the securing of the vehicle has been completed to the service application 110 (step S34).

As described above, the management device 200 secures a vehicle in response to a user's reservation request. A period from when the first acquirer 204 acquires the first notification information to when the manager 208 transmits the first securing notification information on the securing processing to the terminal device 100 of the user

(T1 in FIG. 4) is an example of a “first period”. In the flowchart of FIG. 4, a period from the process of step S10 to the process of step S24 is equivalent to the “first period”. The first securing notification information is an example of the “securing notification information”.

Alternatively, a period from the above-described process of step S10 to the process of step S26 or a period from the above-described process of step S10 to the process of step S34 may be referred to as a “first period”. The first period may be a period from when the above-described process of step S10 is performed to when a predetermined process among the above-described processes of steps S24 to S34 is performed. The second securing notification information may be an example of the “securing notification information”.

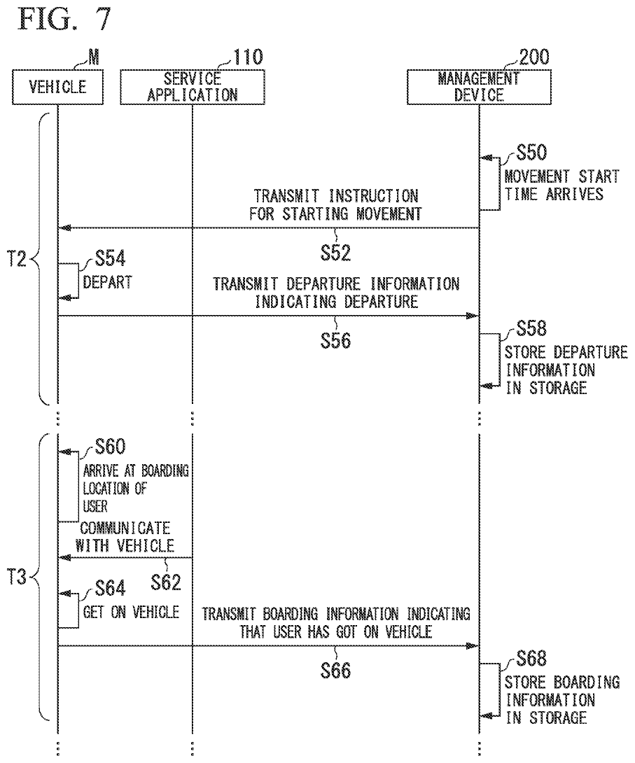

FIG. 7 is a sequence diagram illustrating an example of a flow of processing from when a vehicle starts to move to when a user boards the vehicle. When the time when the secured vehicle M starts to move arrives (step S50), the manager 208 of the management device 200 transmits an instruction for starting movement to the vehicle M (step S52). In a case where a movement start time is stored in the storage device of the vehicle M, the vehicle M may start to move independently of the instruction of the manager 208.

When the vehicle M acquires the instruction for starting movement, the vehicle departs to travel through a route stored in the storage device of the vehicle M (step S54). Next, the vehicle M transmits departure information indicating the departure to the management device 200 (step S56). The management device 200 stores the departure information transmitted by the vehicle M in the storage 250 (step S58).

Next, the vehicle M determines whether or not the vehicle itself has arrived at a user's boarding location (step S60). In a case where the vehicle M has arrived at the boarding location, the user at the boarding location operates the terminal device 100 to communicate with a communicator provided in the vehicle M (step S62). The vehicle M acquires identification information of the user from the terminal device 100, and unlocks a door lock of the vehicle M to permit the user's boarding in a case where the acquired identification information matches identification information of the user which is stored in the storage device of the vehicle M.

The vehicle M determines whether or not the user has boarded the vehicle M (step S64). For example, the vehicle M recognizes the user's boarding based on an image captured by an in-vehicle camera or recognizes the user's boarding in a case where the vehicle has acquired information indicating that the user's boarding has been completed which is transmitted by the terminal device 100.

Next, in a case where the vehicle M has determined that the user has boarded the vehicle M, the vehicle M transmits boarding information indicating that the user has boarded the vehicle M to the management device 200 (step S66). When the vehicle M has acquired the boarding information, the vehicle stores the acquired boarding information in the storage 250 (step S68).

As described above, the management device 200 can recognize the status of the vehicle M and the status of the user. A period from when the management device 200 transmits first securing information (or second securing notification information) to the terminal device 100 or from when the terminal device 100 has received the first securing notification information (or the second securing notification information) to when the secured vehicle M starts to move (T2 in FIGS. 4 and 7) is an example of a “second period”.

A period from the process of step S26 (after S24) in FIG. 4 to the process of step S58 in FIG. 7 is an example of a “second period”. A period from the process of step S26 in FIG. 4 to a predetermined process among the processes of steps S54, S56, and S58 may be a “second period”. The second period may be started at a timing after the process of step S34 in FIG. 4.

A period from when the vehicle M starts to move to when the user boards the vehicle M (T3 in FIG. 7) is an example of a “third period”. A period from the above-described process of step S60 (after S58) to the process of step S68 is an example of a “third period”. A period from the above-described process of step S60 to a predetermined process among the processes of steps S64, S66, and S68 may be a “third period”.

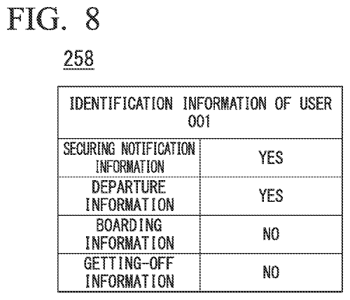

FIG. 8 is a diagram illustrating an example of the details of the status information 258 generated by the manager 208 through the above-described processes of FIGS. 4 and 7. The status information 258 indicates the degree of progress of processing related to the provision of a service for a user's reservation request. The status information 258 indicates whether or not a securing notification has been given, whether or not a departure notification has been given, whether or not a user is getting on the vehicle M, and whether or not the user has got off the vehicle M with respect to identification information of the user.

The example of FIG. 8 indicates that the manager 208 has acquired securing notification information and departure information with respect to the user's reservation request, and indicates a state where boarding information indicating that the user has boarded the vehicle M has not been acquired from the vehicle M. The vehicle M determines whether or not the user has boarded the vehicle M and then has got off the vehicle M. For example, the vehicle M recognizes the user's getting-off based on an image captured by an in-vehicle camera or recognizes that the user has got off the vehicle in a case where information indicating the completion of the user's getting-off which is transmitted by the terminal device 100 has been acquired. The management device 200 performs charging in a case where the user has cancelled a reservation, with reference to the status information 258.

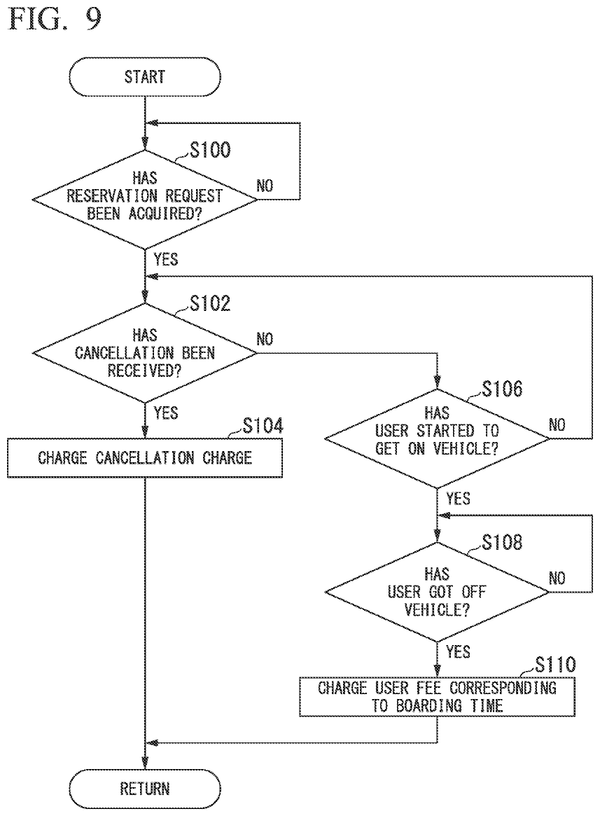

FIG. 9 is a flowchart illustrating an example of a flow of charging processing performed by the information processor 210. The present processing is performed in parallel with, for example, the processes of FIGS. 4 and 7. First, the information processor 210 determines whether or not a reservation request has been acquired (step S100). In a case where the reservation request has been acquired, the information processor 210 determines whether or not the cancellation of a reservation has been received (step S102). The reception means that the second acquirer 206 acquires information on the cancellation of the reservation from the terminal device 100 and that the information processor 210 has recognized that the reservation has been cancelled by the second acquirer 206.

In a case where the cancellation of the reservation has been received, the information processor 210 charges the user a cancellation charge (fee) based on the status information 258 and the charging information 260 to be described later (step S104). The charging means that the information processor 210 associates the cancellation charge with the user. Specifically, the information processor 210 generates the charging information 260 by associating the cancellation charge with the user. Thereby, the processing of the present flowchart is terminated.

In a case where the cancellation of the reservation has not been received, the management device 200 determines whether or not the user has started to board the vehicle with reference to the status information 258 (step S106). In a case where the user has not started to board the vehicle, the processing returns to the process of step S102.

In a case where the user has started to board the vehicle, the management device 200 determines whether or not the user has got off the vehicle with reference to the status information 258 (step S108). In a case where the user has got off the vehicle M, the management device 200 charges the user a fee corresponding to a boarding time (step S110). Thereby, the processing of the present flowchart is terminated.

[Determination of Charging Amount]

FIG. 10 is a diagram illustrating an example of the charging information 260 which is used to describe the determination of a charging amount. The charging information 260 is information in which a charging amount is associated with a timing when a reservation is cancelled or a boarding time (or a boarding distance). A charging amount increases as a user approaches a timing when the user boards the vehicle M arranged in accordance with a reservation request after transmitting the reservation request to the management device 200.

In a case where a reservation has been cancelled in the first period T1, the management device 200 charges a first fee Ch1. Specifically, in a case where a reservation has been cancelled within X minutes (predetermined minutes from the reservation request) in the first period T1, the first fee Ch1A is charged. In a case where a reservation has been cancelled from X minutes to the giving of a vehicle securing notification, a first fee Ch2 larger than the first fee Ch1A is charged. The amount of money charged in the first period T1 is not changed over a plurality of stages and may be a predetermined amount of money.

In a case where a reservation has been cancelled in the second period T2, the management device 200 charges a second fee Ch2. In a case where a reservation has been cancelled in the third period T3, the management device 200 charges a third fee Ch3. The amount of money increases in the order of the first fee Ch1, the second fee Ch2, and the third fee Ch3.

In a fourth period T4, the management device 200 performs charging on a user in accordance with a period of time for which the user is in the vehicle M or a travel distance of the vehicle M on which the user boards. The fourth period T4 is a period of time for which the user is in the vehicle M. The charged amount is, for example, the amount of money which is equal to or greater than a fourth fee or greater than the fourth fee.

In the example of FIG. 10, a cancellation charge and a use fee after a user boards the vehicle M are shown as the same graph, but may be specified by different graphs. In this case, the cancellation charge may be the amount of money which is lower or larger than the use fee after the user boards the vehicle M.

The information processor 210 derives a cancellation charge and a use fee of the user using the charging information 260 to generate the totalization information 262 based on a derivation result.

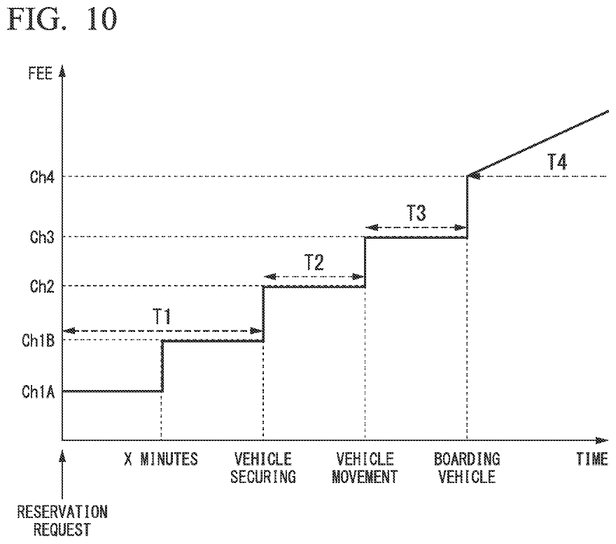

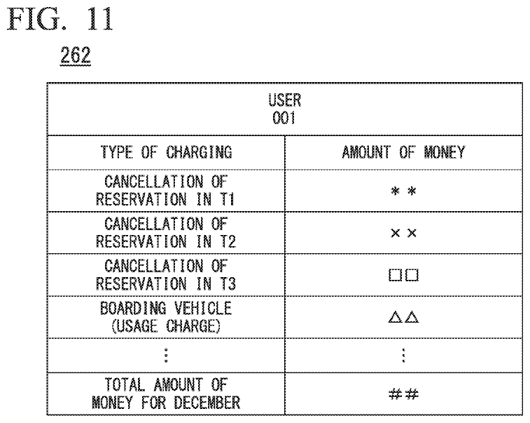

FIG. 11 is a diagram illustrating an example of the details of the totalization information 262. The totalization information 262 is information in which information indicating the type of charging (a use fee or a cancellation charge for a reservation) and the amount of money are associated with identification information of a user. The totalization information 262 includes the sum of amounts of money in a predetermined period.

The information processor 210 totalizes a use fee for a vehicle service at predetermined period intervals as described above and requests the payment device 300 to settle the amount of money which is a totalization result. Thereby, payment is performed in the payment device 300.

Further, the manager 208 may not perform securing processing for securing a vehicle based on first notification information transmitted by a terminal device 100 of a user who is charged a predetermined number of times or more or a predetermined amount of money or more by the information processor 210. For example, in a case where a notification of first notification information is given by a terminal device 100 of a user who is charged a predetermined number of times or more or a predetermined amount of money or more for a predetermined period, the information processor 210 may transmit information indicating that a service cannot be used for a predetermined period to the terminal device 100 of the user. Thereby, the management device 200 can efficiently provide a service and provide a service to a user who is unlikely to change the details of a reservation in preference to a user who is likely to change the details of a reservation.

According to a first embodiment described above, the information processor 210 can improve user convenience by determining a charging amount in accordance with a timing when a reservation is cancelled.

<Second Embodiment>Hereinafter, a second embodiment will be described. In the first embodiment, the management device 200 totalizes a use fee at predetermined period intervals and requests the payment device 300 to perform payment. In the second embodiment, a management device 200 acquires a deposit from a payment device 300 and subtracts a cancellation charge from the deposit in a case where a reservation has been cancelled. Hereinafter, the second embodiment will be described.

FIG. 12 is a flowchart illustrating an example of a flow of processing executed by an information processor 210 according to the second embodiment. First, the information processor 210 determines whether or not a reservation request has been acquired (step S200). In a case where a reservation request has been acquired, the information processor 210 transmits a credit card number and information for requesting a user to operate deposit processing to a terminal device 100 (step S202).

Next, the information processor 210 determines whether or not an operation of accepting the above-described request has been performed (step S204). In a case where information indicating that the operation of accepting the above-described request has been performed has been acquired from the terminal device 100, the information processor 210 requests a payment device 300 to perform deposit processing (step S206). Next, the information processor 210 determines whether or not a deposit in the deposit processing has been acquired from the payment device 300 (step S208).

In a case where a deposit has been acquired, the information processor 210 causes a manager 208 to execute processing related to a reservation request (step S210). Specifically, the information processor 210 causes the manager 208 to start the above-described processes of step S12 and the subsequent steps in FIG. 7. The manager 208 generates a reservation schedule 254 or secures a vehicle M. Thereby, the processing of one routine of the present flowchart is terminated.

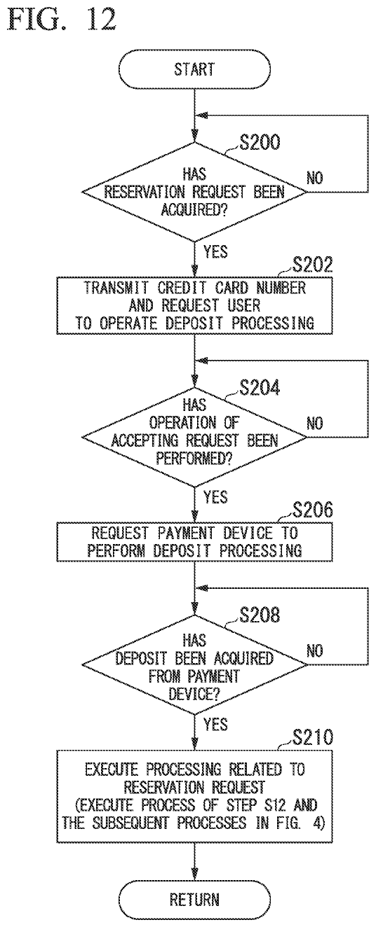

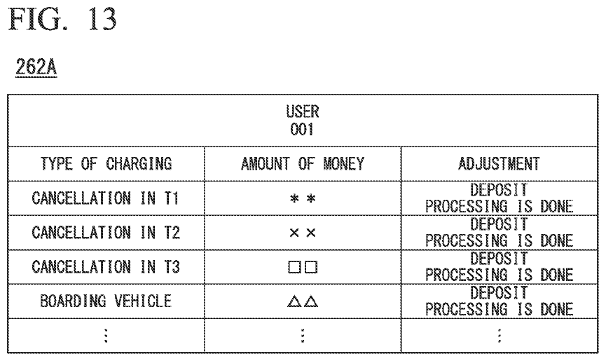

In a case where a reservation has been cancelled or a user uses the vehicle M, the information processor 210 subtracts a cancellation charge or a use fee from the deposit. FIG. 13 is a diagram illustrating an example of the details of totalization information 262A according to the second embodiment. Other payment methods such as credit card payment may be used instead of subtracting one of a cancellation charge and a use fee from a deposit.

According to the second embodiment described above, it is possible to exhibit the same effects as the effects in the first embodiment. Further, according to the second embodiment, a deposit is provided to a provider of a vehicle service, and thus the provider can reliably receive a cancellation charge, and it is possible to give a user a motive to suppress the cancellation of the user.

<Third Embodiment>

Hereinafter, a third embodiment will be described. In the third embodiment, in a case where a management device 200 has acquired a reservation request, the management device incorporates the details of the acquired reservation request into a reservation schedule of a vehicle which is traveling based on a reservation schedule that has been already generated. Hereinafter, the third embodiment will be described.

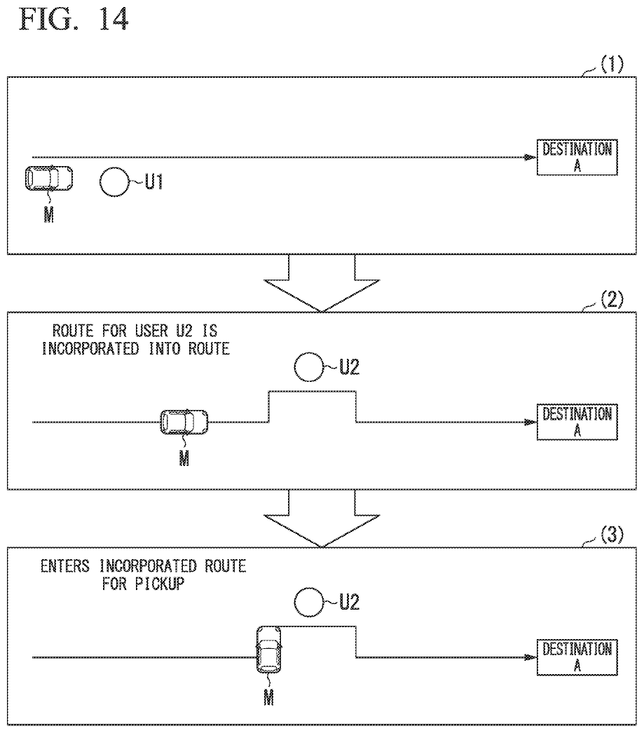

FIG. 14 is a diagram illustrating processing in which an acquired reservation request is incorporated into a reservation schedule. For example, a vehicle M has started to travel in order to pick up a user U1 based on a predetermined reservation schedule 1 (1). Then, the vehicle M transmits a reservation request for a user U2 to head for a destination A to a management device 200 on the way to a destination with the user U1 in the vehicle, and the management device 200 has generated a reservation schedule 1# obtained by correcting the reservation schedule 1 in order to pick up the user U2 based on the reservation request (2). The reservation schedule 1# is a reservation schedule including a route in which a route of the reservation schedule 1 has been changed in order to pick up the user U2. A period from when the user U2 has transmitted a reservation request to when a route corresponding to the reservation request of the user U2 is incorporated into the route of the reservation schedule 1 is another example of a “first period”. The incorporation may mean that the management device 200 has generated the reservation schedule 1# or may mean that the vehicle M has acquired the reservation schedule 1#.

The vehicle M enters a route (a route for picking up the user U2) different from the route of the reservation schedule 1 based on the reservation schedule 1# (3). Then, the vehicle M heads for the destination A with the user U2 in the vehicle. A period from when the route corresponding to the reservation request of the user U2 is incorporated into the route of the reservation schedule 1 to when the vehicle M enters the route different from the route of the reservation schedule 1 is another example of a “second period”.

An information processor 210 determines a cancellation charge based on charging information 260 and a timing when a reservation is cancelled.

According to the third embodiment described above, the management device 200 can charge a user an appropriate fee even when a new user is incorporated into a reservation schedule 254 in a case where the vehicle M is traveling based on the reservation schedule 254.

<Fourth Embodiment>

Hereinafter, a fourth embodiment will be described. In the fourth embodiment, a management device 200 determines a period until a securing notification is transmitted to a terminal device 100, based on an operation state of a vehicle. In a case where a reservation has been cancelled, the management device 200 determines a cancellation charge based on the determined period. Hereinafter, the fourth embodiment will be described.

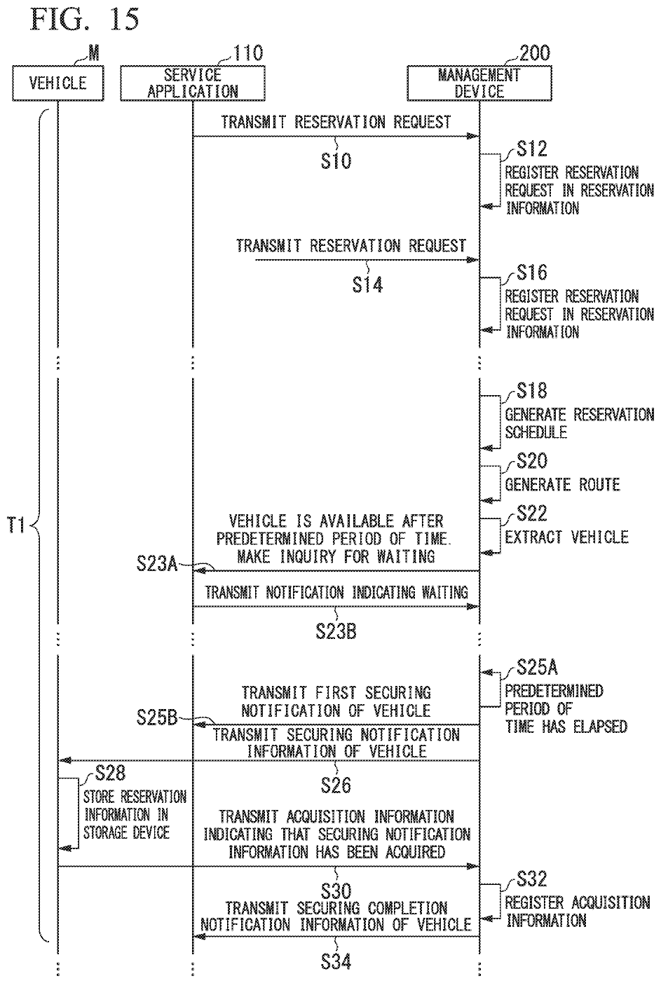

FIG. 15 is a sequence diagram illustrating an example of a flow of processing executed by a vehicle system 1 according to the fourth embodiment. Differences from FIG. 4 will be mainly described. A manager 208 executes a process of extracting a vehicle (step S22). In this case, it is assumed that there is no vehicle M that can be secured immediately, and there is a vehicle M that can be secured after a predetermined period of time. The vehicle M that can be secured after a predetermined period of time is a vehicle that can be used after the predetermined period of time, and for example, means that the vehicle M arrives at a destination of a user after the predetermined period of time, and a task assigned to the vehicle M has been completed.

In this case, the manager 208 can use the vehicle M after a predetermined period of time and inquires of a user whether or not the user can wait for a predetermined period of time (step S23A). A terminal device 100 transmits a notification indicating waiting to the management device 200 according to the user's operation in response to the inquiry (step S23B). Next, when the first acquirer 204 acquires the notification indicating waiting, the manager 208 determines whether or not a predetermined period of time has elapsed (step S25A), and transmits a first securing notification to the terminal device 100 through a communicator 202 after a predetermined period of time has elapsed (step S25B). Next, the manager 208 transmits a second securing notification to the vehicle M through the communicator 202 (step S26). Then, the subsequent processes are executed.

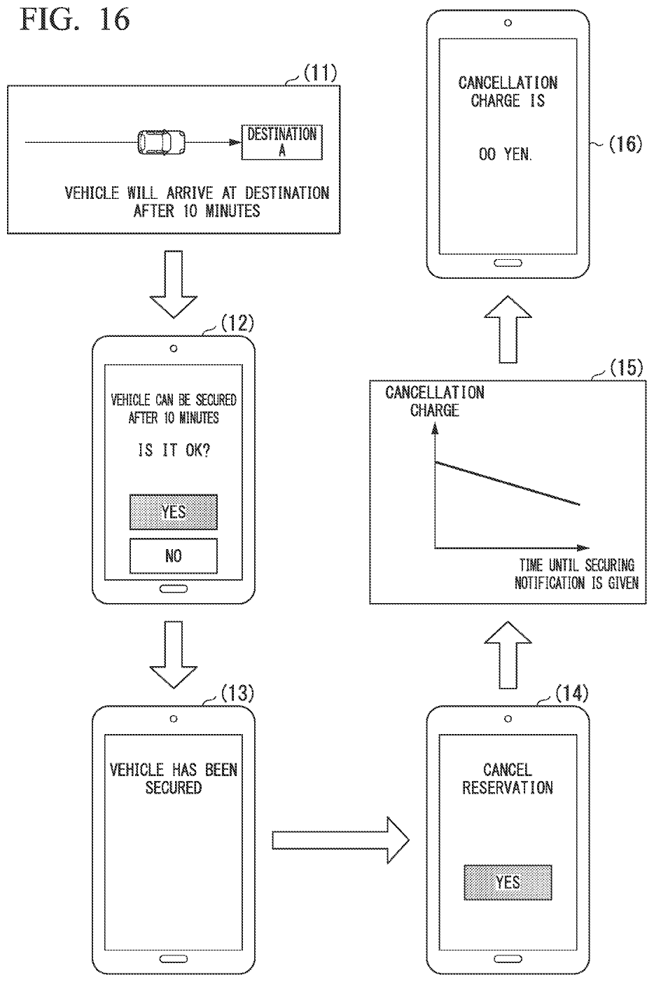

FIG. 16 is a diagram illustrating processing in a case where a reservation has been cancelled. As illustrated in FIG. 16, in a case where the vehicle M arrives at a destination after 10 minutes and the vehicle M becomes available (11), the management device 200 notifies the terminal device 100 that it will take time to secure the vehicle M and inquires a user whether or not the user accepts waiting for a predetermined period of time (12).

In a case where the management device 200 has obtained the user's acceptance, the management device transmits the first securing notification to the terminal device 100 after a predetermined period of time (13). Thereafter, in a case where the user has operated the terminal device 100 to cancel a reservation (14), the management device 200 derives a cancellation charge based on a period from when the user has transmitted a reservation request to when the first securing notification has been received (15), and displays the derived cancellation charge on a display of the terminal device 100 (16).

Here, the cancellation charge changes depending on a period from when the user has transmitted the reservation request to when the securing notification has been received. For example, the cancellation charge decreases as the period until the securing notification is received increases.

According to the fourth embodiment described above, the management device 200 can determine a cancellation charge having a user's burden (user's waiting time) added thereto by determining a period until a securing notification is transmitted to the terminal device 100, based on an operation state of a vehicle.

<Fifth Embodiment>

Hereinafter, a fifth embodiment will be described. In the fifth embodiment, in a case where a reservation has been cancelled, a management device 200 determines a cancellation charge based on the details of a generated reservation schedule. Hereinafter, the fifth embodiment will be described.

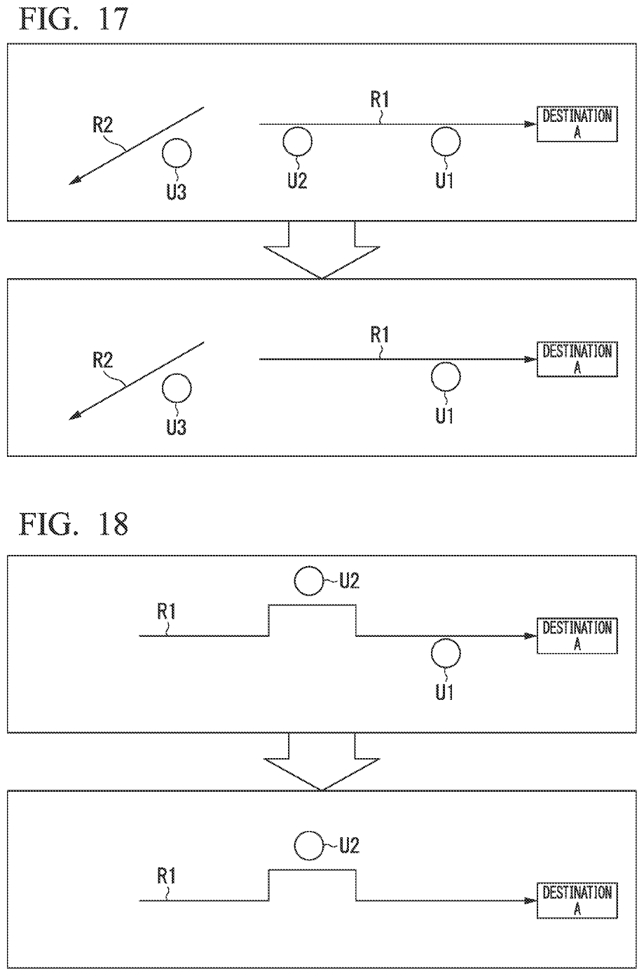

FIG. 17 is a diagram (Part 1) illustrating processing executed by the management device 200 according to the fifth embodiment. It is assumed that a manager 208 has generated a first reservation schedule 1 and a second reservation schedule 2. The first reservation schedule 1 is a route R1 heading for a destination A with a first user U1 and a second user U2 in a vehicle. The second reservation schedule 2 is a route R2 heading for a destination different from the destination A with a third user U3 in the vehicle.

At this time, in a case where the second user U2 (or the first user U1) has cancelled a reservation before a vehicle M moves to pick up the user, a cancellation charge is set to be lower than in a case where the third user cancels a reservation. This is because, even when the second user U2 has cancelled a reservation, the vehicle M heads for the destination A by traveling through the route R1 which is the same as the route R1 through which the vehicle travels in a case where there is a reservation made by the second user U2. In a case where the third user U2 has cancelled a reservation, the vehicle M does not travel through the route R2 generated for the third user U3, and has costs required so far for, such as the generation of the route R2. Accordingly, a cancellation charge in a case where the third user has cancelled a reservation is lower than a cancellation charge in a case where the second user U2 has cancelled a reservation.

In this manner, the management device 200 cancels a reservation based on the details of a generated route, and thus user convenience is improved.

FIG. 18 is a diagram (Part 2) illustrating processing executed by the management device 200 according to the fifth embodiment. It is assumed that the manager 208 has generated a first reservation schedule 1 and a second reservation schedule 2. The first reservation schedule 1 is a route R1 heading for a destination A with a first user U1 and a second user U2 in a vehicle. In addition, the route R1 is a route heading for a destination after picking up the second user U2 by a roundabout route instead of a shortest route heading for the destination.

At this time, in a case where the first user U1 has cancelled a reservation before the vehicle M moves to pick up the user, a cancellation charge is set to be lower than in a case where the second user cancels a reservation. This is because, even when the first user U1 has cancelled a reservation, there is no change made in the route R1 through which the vehicle M travels by a roundabout way to head for the destination A.

According to the fifth embodiment described above, the management device 200 determines a cancellation charge based on the details of a reservation schedule, and thus a cancellation charge with the burden of a service provider added thereto is determined even when a reservation has been cancelled. As a result, user convenience is improved.

Meanwhile, in the above-described examples, the description has been given on the assumption that the second notification information indicating the change of the details of use represents cancellation of a reservation, but alternatively (additionally), a notification indicating the change of the details of use may be the change of a destination or the change of use start time. In this case, as described above, the information processor 210 determines a fee to be charged, in accordance with a timing when second notification information is acquired.

<Sixth Embodiment>

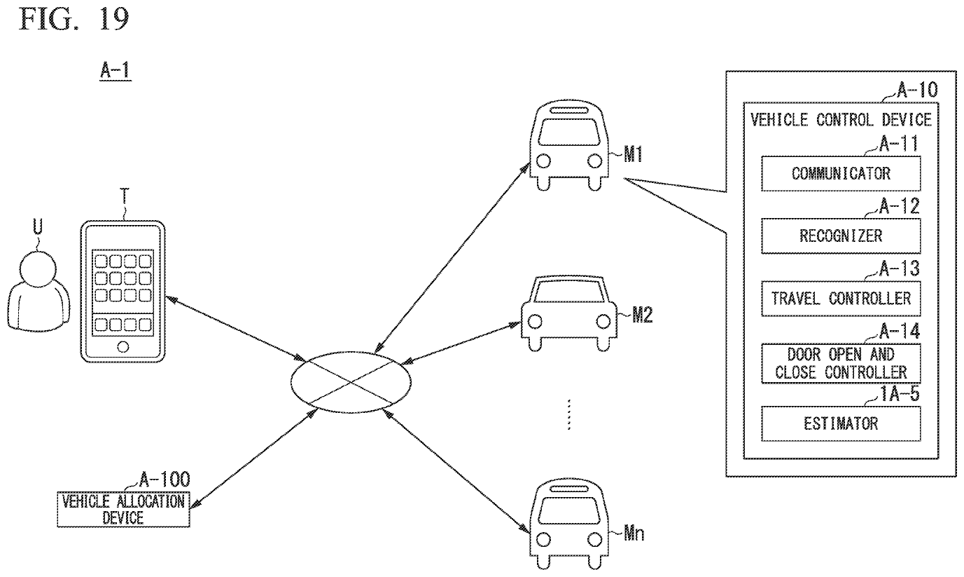

Hereinafter, a sixth embodiment will be described. FIG. 19 is a configuration diagram of a vehicle allocation system A-1. The vehicle allocation system A-1 includes, for example, vehicles M1 to Mn (n is a natural number), a vehicle control device A-10, a vehicle allocation device A-100, and a terminal device T used by a user U of the vehicle allocation system A-1. The vehicles M1 to Mn, the vehicle control device A-10, the vehicle allocation device A-100, and the terminal device T are all connected to a network NW so as to be able to communicate with other equipment. The network NW includes, for example, a cellular network, a Wi-Fi network, Bluetooth (registered trademark), the Internet, a wide area network (WAN), a local area network (LAN), a public line, a provider device, a dedicated line, a wireless base station, and the like. In addition, the vehicles M1 to Mn and the vehicle allocation device A-100 communicate with each other through a communication bus such as a controller area network (CAN) bus, a serial communication line, a wireless communication network, or the like. Hereinafter, the vehicles M1 to Mn will be referred to as a vehicle M in a case where the vehicles are not distinguished from each other.

The terminal device T is a terminal device such as a mobile phone, a smartphone, a tablet terminal, or a personal computer which is used by the user U of the vehicle M. The terminal device T receives a vehicle allocation request of the user U through a dedicated application or a browser and transmits the received vehicle allocation request to the vehicle allocation device A-100. The vehicle allocation request includes a location where the user meets a vehicle which is allocated among the vehicles M1 to Mn, the time of vehicle allocation, a destination after boarding a vehicle, conditions related to a vehicle, and the like. The vehicle allocation request may include a case where a start request for requesting the start of vehicle allocation is included and a case where a change request for requesting the change of an expected meeting place and the time of meeting or the cancellation of vehicle allocation is included. As the expected meeting place, a parking space where one specific vehicle can be parked may be designated, or a parking space where a plurality of vehicles can be parked, such as “a getting on and off place in front of a station” or “a parking lot of a shopping mall” may be designated. In addition, regarding the expected meeting place, the present positional information received from a global positioning system (GPS) of the terminal device T by a receiver of the GPS may be adopted as the present position of the user U.

Some or all of the functions of the vehicle control device A-10 may be realized by on-vehicle devices mounted on the respective vehicles M1 to Mn. Some or all of the functions of the vehicle control device A-10 may be realized by hardware including a circuit (circuitry) such as an LSI, an ASIC, an FPGA, or a GPU, or may be realized by software and hardware in cooperation. Programs may be stored in advance in a storage device including a non-transitory storage medium such as an HDD or a flash memory or may be stored and installed in a detachable non-transitory storage medium such as a DVD or a CD-ROM being mounted on a drive device.

The vehicle control device A-10 includes, for example, a communicator A-11, a recognizer A-12, a travel controller A-13, a door open and close controller A-14, and an estimator A-15.

The communicator A-11 communicates with other vehicles and other devices through a network NW.

The recognizer A-12 recognizes the surrounding circumstances of the vehicle M. The recognizer A-12 acquires information on the surrounding circumstances of the vehicle M from, for example, an on-vehicle camera, a radar device, a light detection and ranging (LIDAR), an object recognition device, a vehicle sensor, a navigation device, or the like to recognize the surrounding circumstances of the vehicle M.

The travel controller A-13 controls the traveling of the vehicle M to be allocated, in response to a vehicle allocation instruction received from the vehicle allocation device A-100. The travel controller A-13 controls a travel route and a travel speed of the vehicle M, for example, based on a place where the vehicle is expected to meet the user U and information on the time of arrival.

The door open and close controller A-14 controls the opening and closing of a door of the vehicle M that has approached an expected meeting place based on an instruction received from the user U. The door open and close controller A-14 performs a pre-stop door open operation of starting to open a door through which the user U boards the vehicle M among the doors of the vehicle M even in a state where the vehicle M does not completely stop in a case where a predetermined door open condition is satisfied. The pre-stop door open operation will be described later.

The estimator A-15 performs estimation related to meeting between the user U and the vehicle M in the expected meeting place. The estimator A-15 estimates whether or not the vehicle M can pick up the user U in the expected meeting place, whether or not the vehicle M can stop in the expected meeting place, whether or not the vehicle M can pick up the user U by changing an expected meeting place, and the like.

The vehicle allocation device A-100 receives a vehicle allocation request from the terminal device T, determines a vehicle M to be allocated, and directs the vehicle M to an expected meeting place for the user U. Some or all of the functions (except for a storage A-190) of the vehicle allocation device A-100 may be realized by hardware including a circuit (circuitry) such as an LSI, an ASIC, an FPGA, or a GPU, or may be realized by software and hardware in cooperation. Programs may be stored in advance in a storage device including a non-transitory storage medium such as an HDD or a flash memory or may be stored and installed in a detachable non-transitory storage medium such as a DVD or a CD-ROM being mounted on a drive device.

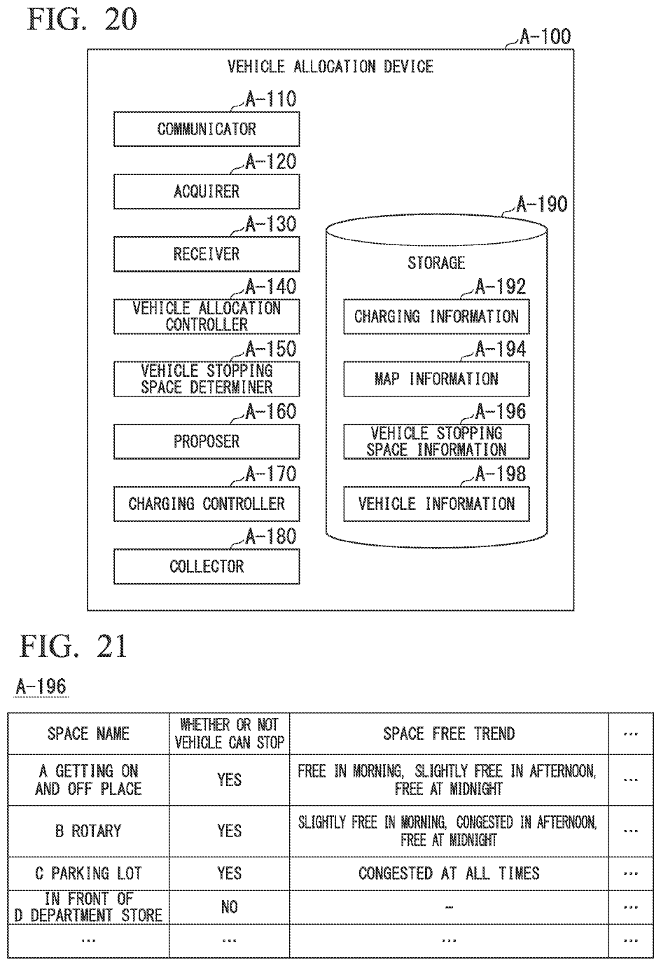

FIG. 20 is a configuration diagram of the vehicle allocation device A-100. The vehicle allocation device A-100 includes, for example, a communicator A-110, an acquirer A-120, a receiver A-130, a vehicle allocation controller A-140, a vehicle stopping space determiner A-150, a proposer A-160, a charging controller A-170, a collector A-180, and a storage A-190.

The communicator A-110 communicates with the vehicle M and other devices such as the vehicle control device A-10 and the terminal device T through the network NW.

The acquirer A-120 acquires a recognition result of the recognizer A-12 of the vehicle M to acquire information on the surrounding circumstances of the vehicle M. The acquirer A-120 acquires information on the surrounding circumstances of the vehicle M that is approaching particularly an expected meeting place. The acquirer A-120 is an example of a “second acquirer”.

The receiver A-130 receives a vehicle allocation request from the terminal device T of the user U received by the communicator A-110. In addition, the receiver A-130 receives a response of the user U to a proposal of the proposer A-160 to be described later, the response being transmitted from the terminal device T to the communicator A-110. The receiver A-130 is an example of a “first acquirer”, and the proposer A-160 is an example of a “second processor”.

The vehicle allocation controller A-140 selects a preferred vehicle from among the vehicles M1 to Mn based on the vehicle allocation request received by the receiver A-130 and directs the selected vehicle to an expected meeting place designated by the user U. The vehicle allocation controller A-140 transmits a vehicle allocation instruction including information of the expected meeting place to the selected vehicle through the communicator A-110. In the following description, a vehicle M selected to be directed to an expected meeting place by the vehicle allocation controller A-140 from among the vehicles M1 to Mn may be referred to as an “allocated vehicle”.

In a case where an allocated vehicle has approached an expected meeting place, the vehicle stopping space determiner A-150 determines whether or not there is a vehicle stopping space for stopping the allocated vehicle in a place designated as the expected meeting place or a region designated as the expected meeting place. The vehicle stopping space determiner A-150 may determine a vehicle stopping space based on the actual congestion situation at a point in time when the allocated vehicle has approached the expected meeting place, or may determine a vehicle stopping space after predicting a congestion situation in advance at a point in time when the allocated vehicle arrives in the expected meeting place.

The proposer A-160 proposes an alternative meeting place different from an expected meeting place to the user U in a case where the vehicle stopping space determiner A-150 determines that there is no vehicle stopping space in an expected meeting place. The proposer A-160 proposes an alternative meeting place to the user U by determining whether or not there is an empty space around an expected meeting place (for example, in a case where the expected meeting place is the shoulder of a road, a range of approximately 1 to 2 blocks from the expected meeting place, in addition to a range of several vehicles before and after the expected meeting place). Further, in a case where the expected meeting place is a specific parking lot, the proposer A-160 proposes an alternative meeting place to the user U by determining whether or not there is an empty space in the parking lot around the expected meeting place.

Further, in a case where the vehicle stopping space determiner A-150 determines that there is no vehicle stopping space in the expected meeting place and a preferred alternative meeting place is not found, the proposer A-160 proposes to the user U that a vehicle allocation service is to be cancelled. In a case where the vehicle stopping space determiner A-150 determines that there is no vehicle stopping space in the expected meeting place and a preferred alternative meeting place is not found, the proposer A-160 may propose to the user U that the time of meeting be changed to the time when it is estimated that the expected meeting place will be available.

The charging controller A-170 charges the user U a vehicle allocation service charge based on a reception result of the receiver A-130. For example, the charging controller A-170 charges the user U a vehicle allocation service charge, charges the user U an alteration fee in a case where an expected meeting place or the time is changed due to circumstances of the user U, or charges the user U a cancellation charge in a case where vehicle allocation is cancelled due to circumstances of the user U.

The collector A-180 collects a reception result of the receiver A-130, a vehicle allocation control result of the vehicle allocation controller A-140, a determination result of the vehicle stopping space determiner A-150, a proposal result of the proposer A-160, and the like.

The collector A-180 reflects an expected meeting place included in the reception result of the receiver A-130 or the vehicle allocation control result of the vehicle allocation controller A-140 and information on a place where the user U and an allocated vehicle have actually met in map information A-194. In addition, the collector A-180 reflects the determination result of the vehicle stopping space determiner A-150 in vehicle stopping space information A-196.

The storage A-190 is realized by various storage devices, an electrically erasable programmable read only memory (EEPROM), a read only memory (ROM), a random access memory (RAM), or the like. The storage A-190 stores, for example, charging information A-192, map information A-194, vehicle stopping space information A-196, vehicle information A-198, programs, and various other information.

FIG. 21 illustrates an example of information stored in the vehicle stopping space information A-196. The vehicle stopping space information A-196 stores information such as a space name, whether or not an allocated vehicle can stop, and a space empty tendency. The vehicle stopping space information A-196 may include information on a place where designation as an expected meeting place cannot be received (information indicating that the stop of a vehicle is “impossible”), in addition to information on a place where designation as an expected meeting place can be received.

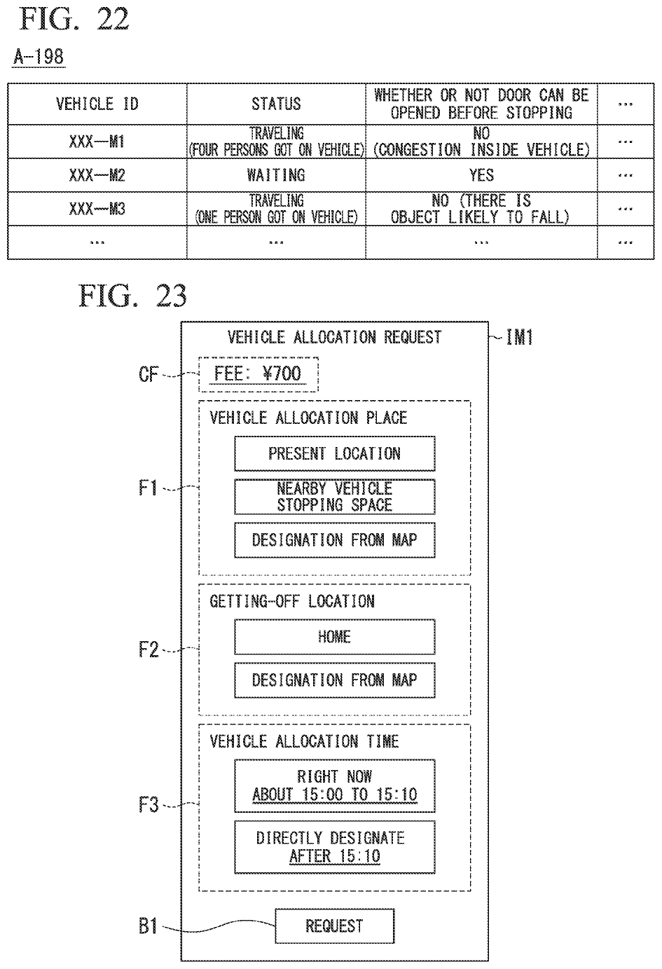

FIG. 22 illustrates an example of information stored in the vehicle information A-198. The vehicle information A-198 stores a vehicle ID for identifying a vehicle, the status of a vehicle, and information on whether or not a door is opened before stopping.

[Vehicle Allocation Request]FIG. 23 is a diagram illustrating an example of an image IM1 displayed on a terminal device T when a vehicle allocation request is made. The image IM1 includes an input frame F1 for receiving designation of a vehicle allocation place, an input frame F2 for receiving designation of a getting-off place, an input frame F3 for receiving designation related to the time of vehicle allocation, a charged amount display frame CF according to the charging controller A-170 based on conditions designated in the input frames F1 to F3, a request button B1 for transmitting a vehicle allocation request to the vehicle allocation device A-100, and the like. In the input frame F1 and the input frame F2, candidates of a vehicle allocation place are displayed, for example, based on the vehicle stopping space information A-196. The user U operates the request button B1 in a state where a condition related to vehicle allocation has been input to the input frame F1 to F3 to transmit a vehicle allocation request to the vehicle allocation device A-100.

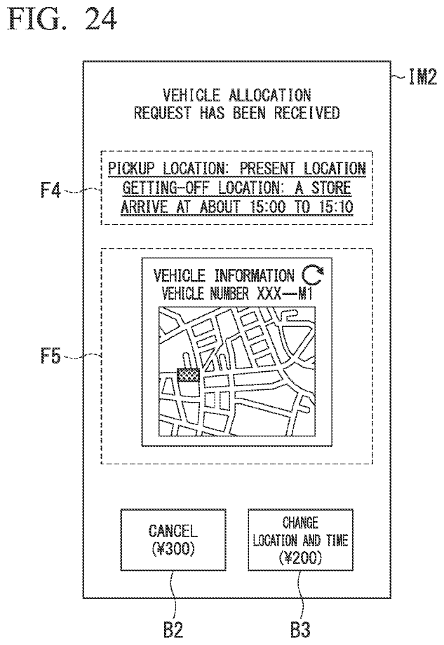

FIG. 24 is a diagram illustrating an example of an image IM2 displayed on a terminal device T when a vehicle allocation request is received. The image IM2 is an example of an image in which a result obtained by receiving a vehicle allocation request transmitted from the terminal device T through the image IM1 illustrated in FIG. 23 by the vehicle allocation device A-100 is displayed on the terminal device T.

The image IM2 includes a display frame F4 for displaying a result received by the vehicle allocation device A-100, a display frame F5 for displaying information on an allocated vehicle, a cancellation button B2 for cancelling vehicle allocation, a place and time change button B3 for changing a vehicle allocation condition, and the like. The cancellation button B2 and the place and time change button B3 are operated by a user in a case where a vehicle allocation plan is changed due to circumstances of the user U. In the cancellation button B2 and the place and time change button B3 illustrated in the drawing, the amount of money to be charged by the charging controller A-170 is also displayed in a case where the buttons are operated.

In a case where the receiver A-130 has accepted that the user U has operated the place and time change button B3, for example, the image IM1 is displayed on the terminal device T again to receive the change of an expected meeting place or the time.

In a case where the operation of the cancellation button B2 has been received by the receiver A-130, the vehicle allocation controller A-140 notifies the vehicle M that vehicle allocation has been cancelled to stop vehicle allocation.

[Determination of Vehicle Stop Space]

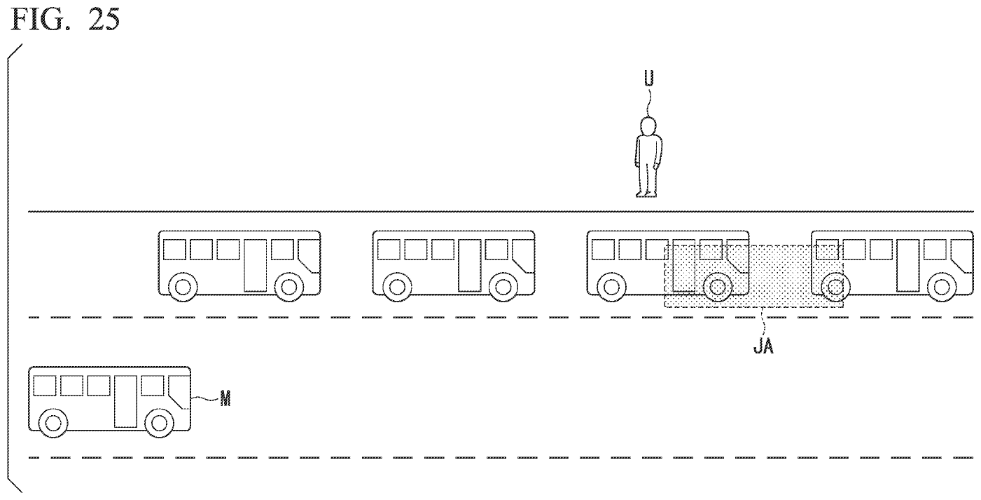

FIG. 25 is a diagram illustrating a first scene. The first scene is a scene for describing a process in which the vehicle M is approaching an expected meeting place and the vehicle stopping space determiner A-150 determines whether or not there is an empty space in an expected meeting place.

In a case where the vehicle M has approached an expected meeting place JA, the vehicle stopping space determiner A-150 determines whether or not there is a vehicle stopping space in the expected meeting place JA. In a case where a parking space in which one vehicle can be parked is designated as the expected meeting place JA as illustrated in the drawing, the vehicle stopping space determiner A-150 determines whether or not the vehicle M can stop in the expected meeting place JA. Further, in a case where a parking space in which a plurality of vehicles can be parked is designated as the expected meeting place JA, the vehicle stopping space determiner A-150 determines whether or not there is an empty space in which the vehicle M can stop in the region of the expected meeting place JA.

In the example illustrated in the drawing, another vehicle stops in the expected meeting place JA, and thus the vehicle stopping space determiner A-150 determines that there is no vehicle stopping space.

[Change of Expected Joining Place]

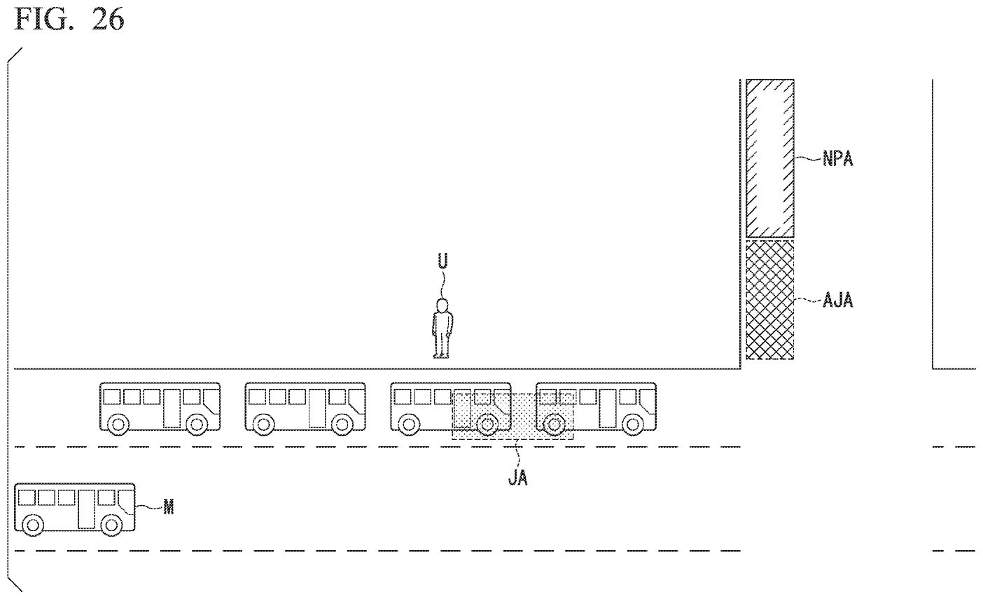

FIG. 26 is a diagram illustrating a second scene. The second scene is a scene for describing processing for proposing an alternative meeting place which is performed by the proposer A-160.

In a case where the vehicle stopping space determiner A-150 determines that there is no vehicle stopping space in the expected meeting place JA, the proposer A-160 searches for an alternative meeting place. The proposer A-160 proposes a place that can be a vehicle stopping space as an alternative meeting place at a point in time when the vehicle M arrives at the location with reference to the map information A-194, and the vehicle stopping space may not be empty at the point of time of proposal. Meanwhile, even when a region such as a vehicle-stop-prohibited region NPA illustrated in the drawing or a vehicle entrance of facility is vacant with reference to the map information A-194, the proposer A-160 does not propose the region as an alternative meeting place.

In a case where an alternative meeting place has been once proposed, and then another preferred alternative meeting place (for example, a place that includes a vehicle stopping space and has a small amount of movement from the present location of the user U) has not been found, the proposer A-160 may perform a process of further proposing an alternative meeting place.

Even when an expected meeting place is changed to an alternative meeting place in this manner, the charging controller A-170 does not charge a vehicle allocation service charge related to movement to the alternative meeting place. This is because recommending the user U to actively change the expected meeting place to the alternative meeting place is reflected in a service charge since the user U and the vehicle M can effectively meet each other by the user U changing the expected meeting place to the alternative meeting place.

For example, in a case where the user U has selected waiting without changing the expected meeting place, the vehicle M waits in the vicinity of the expected meeting place until a vehicle stopping space is formed in the expected meeting place, which is likely to cause congestion around the expected meeting place or obstruct the passing of other vehicles. Further, in a case where the user U has selected waiting without changing the expected meeting place, there is a possibility that control costs, such as the change of a travel schedule of an allocated vehicle after the user U boards the vehicle or the change of an allocated vehicle for another user, will be incurred.

For this reason, the charging controller A-170 does not perform additional charging at the time of changing the expected meeting place to the alternative meeting place so that a charged amount is reduced for a user U who cooperates in efficiently allocating the vehicle M by the vehicle allocation system A-1.

Hereinafter, description will be given on the assumption that the proposer A-160 proposes an alternative meeting place AJA in an example illustrated in the drawing.

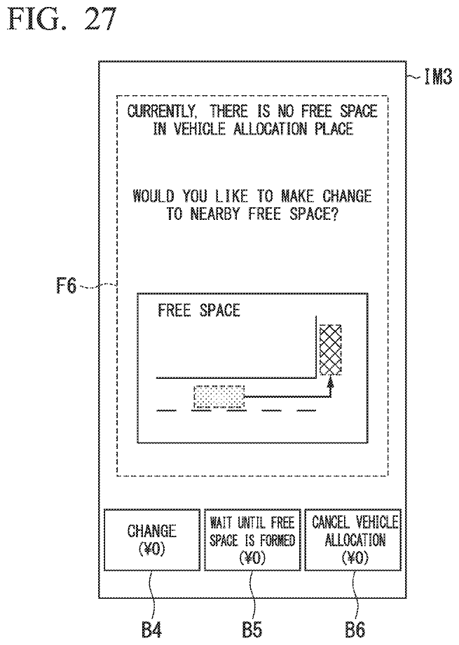

FIG. 27 is a diagram illustrating an example of an image IM3 displayed on a terminal device T with regard to the details of a proposal made by the proposer A-160.

In a case where the proposer A-160 proposes an alternative meeting place, the receiver A-130 receives a response including information regarding whether or not to make a change to an alternative meeting place from a user U. The image IM3 is an example of an image displayed on the terminal device T when a response including information regarding whether or not make a change to an alternative meeting place is received.

The image IM3 includes a display frame F6 for displaying the details of a proposal made by the proposer A-160, a change button B4 for changing a meeting place to an alternative meeting place displayed in the display frame F6, a button B5 for waiting until a vehicle stopping space is formed without changing an expected meeting place, a vehicle allocation cancellation button B6 for cancelling vehicle allocation itself, and the like. In the change button B4, the vacancy waiting button B5, and the vehicle allocation cancellation button B6, the amount of money charged by the charging controller A-170 is also displayed in a case where the buttons are operated. The charging controller A-170 does not charge an additional charge even when an expected meeting place is changed to an alternative meeting place for the vehicle M due to the change button B4 selected by the user U, even when a change from an expected meeting place is not made due to the vacancy waiting button B5 selected by the user U, and even when vehicle allocation itself is cancelled due to the vehicle allocation cancellation button B6 selected by the user U.

In a case where the receiver A-130 has accepted that the user U has operated the change button B4, the vehicle allocation controller A-140 instructs the vehicle M to change a meeting place to an alternative meeting place. In a case where the receiver A-130 has accepted that the user U has operated the vacancy waiting button B5, the vehicle allocation controller A-140 instructs the vehicle M to estimate that there is a vehicle stopping space for stopping an allocated vehicle in an expected meeting place (or a vehicle stopping space is formed) and to cause the vehicle to head for the expected meeting place as scheduled. In a case where the receiver A-130 has accepted that the user U has operated the vacancy waiting button B5 and a vehicle stopping space for stopping an allocated vehicle is not formed even when the vehicle has approached an expected meeting place, the vehicle allocation controller A-140 may cause the allocated vehicle to travel nearby, temporarily stop, or wait until a vehicle stopping space is formed. Further, in a case where the receiver A-130 has accepted that the user U has operated the vacancy waiting button B5 and a vehicle stopping space for stopping an allocated vehicle is not formed even when the vehicle has approached an expected meeting place, the vehicle allocation controller A-140 may cause the proposer A-160 to propose an alternative meeting place again. Further, in a case where a “no change” button is set together with the change button B4 and the user U has operated the “no change” button, the vehicle allocation controller A-140 may estimate that there is a vehicle stopping space for stopping an allocated vehicle in an expected meeting place (or a vehicle stopping space is formed) and may instruct the vehicle M to head for the expected meeting place as scheduled.

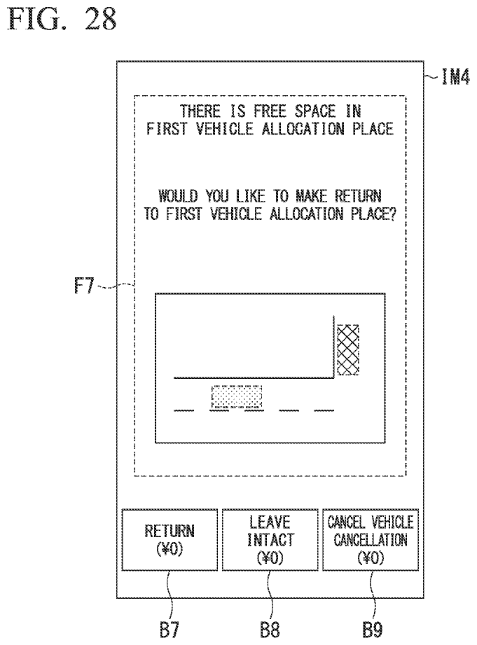

FIG. 28 is a diagram illustrating an example of an image IM4 displayed on a terminal device T with regard to the details of a proposal made by the proposer A-160.

Even when an alternative meeting place has been proposed by the proposer A-160, the vehicle stopping space determiner A-150 may continuously determine whether or not there is a vehicle stopping space in an expected meeting place until the vehicle M arrives at the expected meeting place or the alternative meeting place. At this time, in a case where the proposer A-160 has already proposed an alternative meeting place to the user U and the vehicle stopping space determiner A-150 has determined that there is a vehicle stopping space in the expected meeting place, the proposer A-160 can notify (propose) the terminal device T of the user U that a change to the alternative meeting place can be cancelled to return a meeting place to the expected meeting place.

The image IM4 includes a display frame F6 for displaying the details of a proposal made by the proposer A-160, a return button B7 for changing a meeting place displayed in the display frame F6 again from an alternative meeting place to an original expected meeting place, a leave intact button B8 for keeping a change to an alternative meeting place, a vehicle allocation cancellation button B9 for rejecting an alternative meeting place and cancelling vehicle allocation itself, and the like. In the return button B7, the leave intact button B8, and the vehicle allocation cancellation button B9, the amount of money to be charged by the charging controller A-170 is also displayed in a case where the buttons are operated.

At this time, the charging controller A-170 does not charge a vehicle allocation service charge related to the change of an expected meeting place in any of (1) a case where the leave intact button B8 is selected by the user U to continuously select an alternative meeting place, (2) a case where the return button B7 is selected by the user U to return an expected meeting place to the original meeting place, and (3) a case where the vehicle allocation cancellation button B9 is selected by the user U to cancel vehicle allocation itself.

[Charging Based on Joining Place]

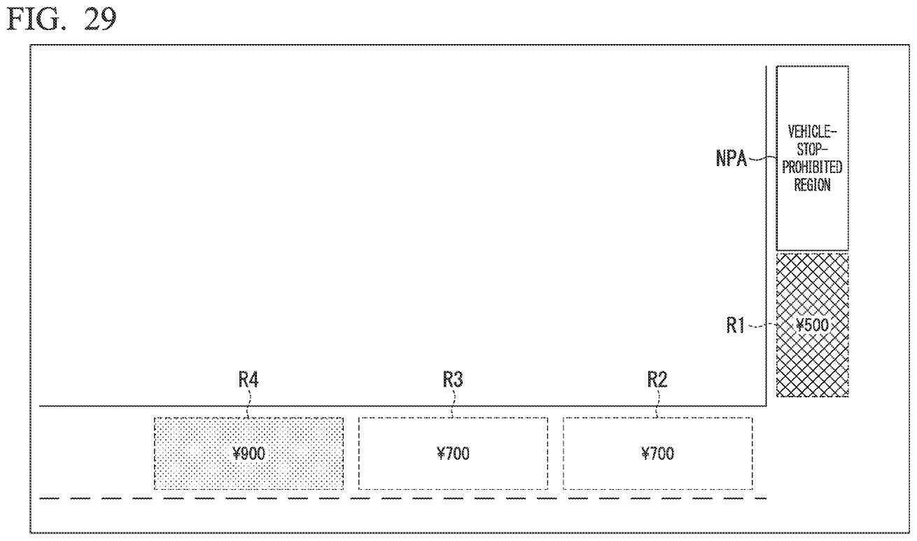

FIG. 29 is a diagram illustrating collecting processing performed by the collector A-180. The collector A-180 collects determination results related to an expected meeting place and an alternative meeting place obtained by the vehicle stopping space determiner A-150, the determination results being stored in the vehicle stopping space information A-196. The collector A-180 collects, for example, the probability of an expected meeting place being able to be used as scheduled, the probability of an expected meeting place being changing to an alternative meeting place, the probability of an alternative meeting place being returned to an expected meeting place, and the like for each expected meeting place to collect information on an availability trend of a vehicle stopping space.

Further, in a case where there is no vehicle stopping space in an expected meeting place, the collector A-180 may further collect the probability of an alternative meeting place being easily found.

For example, a map image having collecting results of the collector A-180 reflected therein is displayed in the input frame F1 of the image IM1 for receiving a vehicle allocation request to receive designation of a vehicle allocation place, and thus the user U determines an expected meeting place after understanding whether or not the place is a place where a vehicle stopping space is easily found. Accordingly, it is possible to make it easy for the user U to understand a proposal to change an expected meeting place to an alternative meeting place by the vehicle allocation system A-1. In addition, a place where a vehicle stopping space is easily found can be recommended as a vehicle allocation place by displaying a map image having collecting results of the collector A-180 reflected therein to accept designation of a vehicle allocation place, and thus it becomes easier for the user U to meet an allocated vehicle.

The charging controller A-170 may change a charging rate for an expected meeting place based on collecting results for an availability trend of a vehicle stopping space which is obtained by the collector A-180. The charging rate for the expected meeting place may be reflected in a basic vehicle allocation service charge or may be reflected in a change fee or a cancellation charge. In the example illustrated in the drawing, referring to collecting results of the collector A-180, a lower vehicle allocation fee is set for a place R1 which is recommended to the user U by the vehicle allocation system A-1 than vehicle allocation fees that are set for other places R2 to R4. Further, in the example illustrated in the drawing, referring to the collecting results of the collector A-180, a higher vehicle allocation fee is set for the place R4 which is not recommended to the user U by the vehicle allocation system A-1 than vehicle allocation fees that are set for the other places R1 to R3. Meanwhile, in the example illustrated in the drawing, a region in which a vehicle cannot stop, such as a zebra zone, is displayed like a vehicle-stop-prohibited region NPA so that designation as an expected meeting place is not accepted.

[Processing Flow]

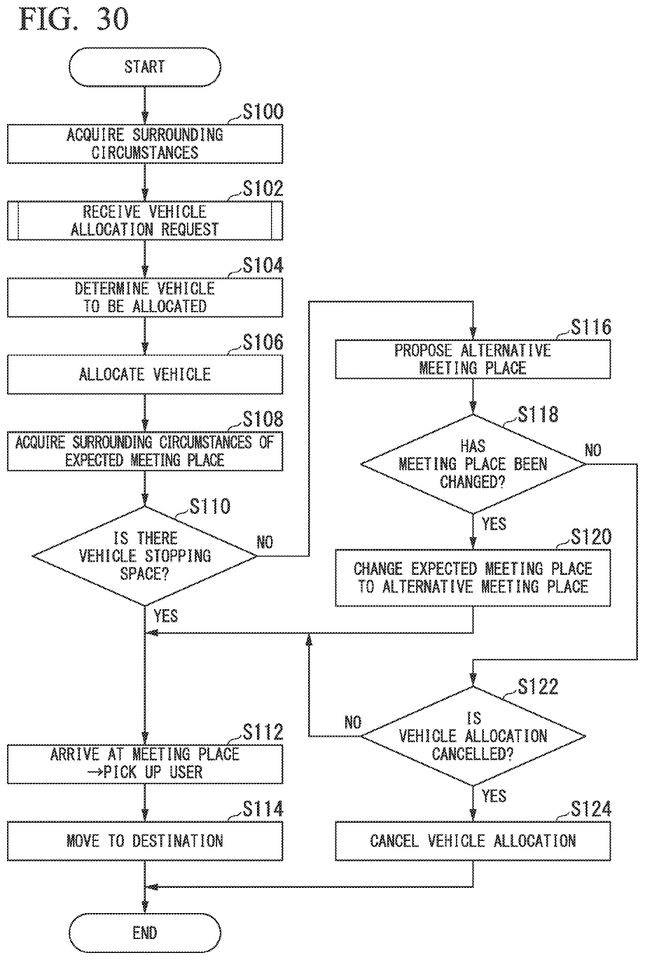

FIG. 30 is a flowchart illustrating an example of a flow of vehicle allocation processing performed by the vehicle allocation system A-1.

First, the acquirer A-120 acquires surrounding circumstances from the vehicles M1 to Mn (step S100). Next, the receiver A-130 receives a vehicle allocation request from a user U (step S102). Details of step S102 will be described later.

Next, the vehicle allocation controller A-140 determines a vehicle to be allocated among the vehicles M1 to Mn (step S104), and directs the determined vehicle to be allocated to an expected meeting place (step S106).

Next, the acquirer A-120 acquires the surrounding circumstances of the expected meeting place (step S108). Next, the vehicle stopping space determiner A-150 determines whether or not there is a vehicle stopping space in the expected meeting place (step S110). In a case where it is determined that there is a vehicle stopping space, the vehicle allocation controller A-140 directs the allocated vehicle to the expected meeting place to pick up the user U (step S112), and moves the allocated vehicle to a destination (step S114). In a case where it is determined that there is no vehicle stopping space, the proposer A-160 proposes an alternative meeting place (step S116). Next, the receiver A-130 receives a response regarding whether to change a meeting place from the expected meeting place to the alternative meeting place from the user U (step S118). In a case where a response indicating the change of a meeting place to the alternative meeting place has been received, the vehicle allocation controller A-140 directs the allocated vehicle to the alternative meeting place (step S120), and causes the processing to proceed to step S112. In a case where a response indicating the change of a meeting place to the alternative meeting place has not been received, the receiver A-130 determines whether the response received in step S118 is a response indicating that vehicle allocation itself is cancelled or a response indicating that a meeting place is kept as the expected meeting place (step S122). In a case where the response indicating that the expected meeting place is maintained has been received, the vehicle allocation controller A-140 causes the processing to proceed to step S112. In a case where a response indicating that a proposal of the alternative meeting place is rejected and vehicle allocation itself is cancelled has been received, the allocated vehicle is notified of the cancellation (step S124), and the processing of the present flowchart is terminated.

Meanwhile, in a case where it is not determined in step S122 that the response is a response indicating that vehicle allocation itself is cancelled, the processes of steps S110 to S122 may be performed repeatedly until the vehicle arrives at the expected meeting place (or the alternative meeting place). For example, after step S120 is executed to change a meeting place to the alternative meeting place, the processing returns to step S110, and the vehicle stopping space determiner A-150 determines whether or not a vehicle stopping space has been formed in the first expected meeting place. In step S116, the proposer A-160 proposes to the user U that a meeting place is returned to the first expected meeting place. In step S120, the receiver A-130 receives a response regarding whether to keep a meeting place changed to the alternative meeting place or to return a meeting place to the first expected meeting place from the user U and outputs a response result to the vehicle allocation controller A-140 to cause the user U to direct the allocated vehicle to the designated meeting place.

In addition, for example, after step S120 is executed and a meeting place has been changed to the alternative meeting place, the processing is returned to step S110, and the vehicle stopping space determiner A-150 may determine whether or not there is another preferred alternative meeting place. In this case, the proposer A-160 proposes another alternative meeting place in step S116.

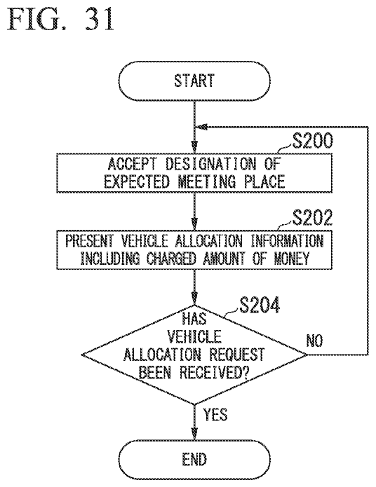

FIG. 31 is a flowchart illustrating an example of a flow of processing for designating an expected meeting place which is performed by the vehicle allocation device A-100. FIG. 31 is equivalent to processing performed in a case where a vehicle allocation request is received in step S102 of FIG. 30.

First, the receiver A-130 accepts designation of an expected meeting place (step S200). Next, the receiver A-130 causes the charging controller A-170 to calculate a charged amount based on the expected meeting place and transmits a reception result including the charged amount to a terminal device T (step S202). Next, the receiver A-130 determines whether or not a request for vehicle allocation to the expected meeting place received in step 5200 has been received from the terminal device T (step S204).

In a case where the receiver A-130 has not received the vehicle allocation request in step S204, the processing is returned to step S200. In a case where the receiver A-130 has received the vehicle allocation request in step S204, the processing of the present flowchart is terminated.

[Pre-stop Door Open Operation]

The receiver A-130 performs advance reception regarding whether or not a user U desires a pre-stop door open operation for starting to open a door which is used at the time of getting on an allocated vehicle even in a state where the allocated vehicle does not stop completely by the user U.

The pre-stop door open operation is performed only in a case where predetermined door open conditions are satisfied. The predetermined door open conditions include, for example, surrounding environment conditions of an expected meeting place, allocated-vehicle-side conditions related to the inside of a vehicle M, and user-side conditions related to the user U.

The surrounding environment conditions include, for example, a condition that a pre-stop door open operation is permitted in a meeting place, a condition that there is no traffic participant other than the user U around the meeting place, and a condition that a traffic participant other than the user U around the meeting place is not moving. The allocated-vehicle-side conditions include, for example, a condition that there is no object likely to fall down due to door open inside the allocated vehicle, a condition related to sitting positions of other users who have gotten on the allocated vehicle (another user is not sitting on a seat close to an opened door), and the like. The user-side conditions include, for example, a condition that it is not necessary to open the rear hatch or the like to store the user's luggage because the user's luggage is less than a predetermined amount.

Meanwhile, the door open and close controller A-14 stops pre-stop door opening in a case where the predetermined door open conditions are not satisfied before a pre-stop door open operation is started or in the middle of the pre-stop door open operation even when an instruction for the pre-stop door open operation has been received.

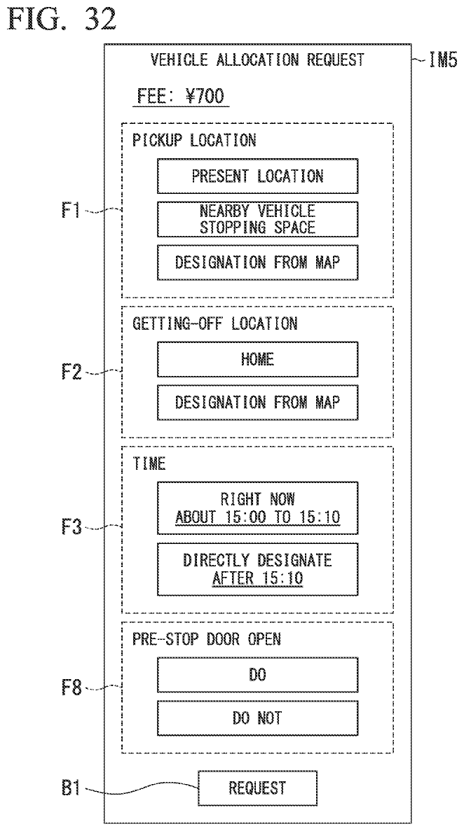

FIG. 32 is a diagram illustrating an example of an image IM5 displayed on a terminal device T when a vehicle allocation request including a request for a pre-stop door open operation is made.

Compared to the image IM1, an input F8 for receiving designation related to whether or not to perform a pre-stop door open operation is further displayed in the image IMS.

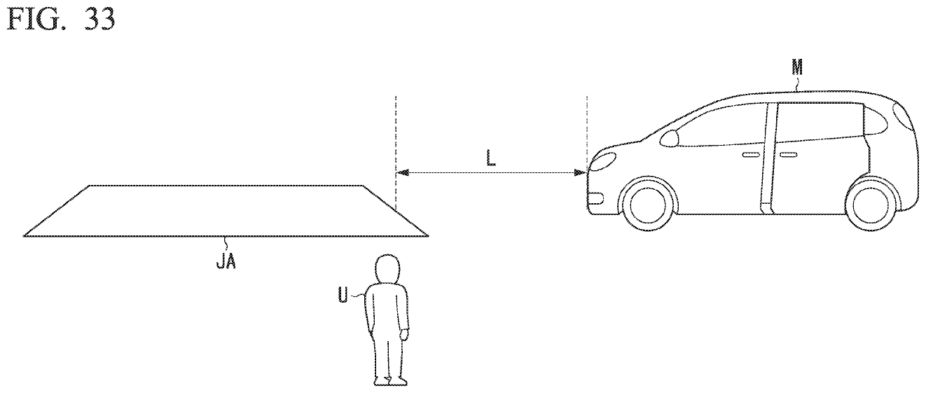

FIGS. 33 to 35 are diagrams illustrating a third scene. The door open and close controller A-14 controls the opening and closing of a door of an allocated vehicle that has approached an expected meeting place based on an instruction received from a user U.

In a case where a vehicle M approaches an expected meeting place JA at a predetermined distance L as illustrated in FIG. 33, the door open and close controller A-14 controls a pre-stop door open operation for starting to open a door which is used when the user U boards the vehicle M even in a state where the vehicle M does not stop completely.

At this time, for example, in a case where the vehicle M performs a pre-stop door open operation, the estimator A-15 starts estimation related to meeting between the user U and the vehicle M in the expected meeting place. For example, in a case where an estimation result of the estimator A-15 is an estimation result indicating that a pre-stop door open operation can be performed, the travel controller A-13 causes the vehicle M to travel at a lower speed than in a case where a pre-stop door open operation is not performed.

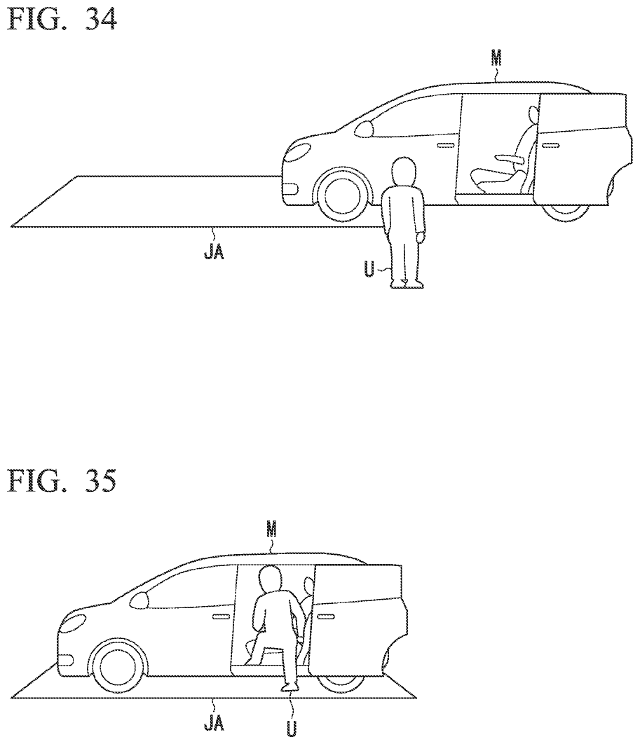

As illustrated in FIG. 34, the travel controller A-13 further causes the vehicle M to travel to the expected meeting place JA. At this time, the user U may start to approach the expected meeting place JA.

As illustrated in FIG. 35, the travel controller A-13 causes the vehicle M with a door opened to stop at the expected meeting place JA. Thereby, the user U can board the vehicle M immediately after the vehicle M stops.

[Processing Flow]

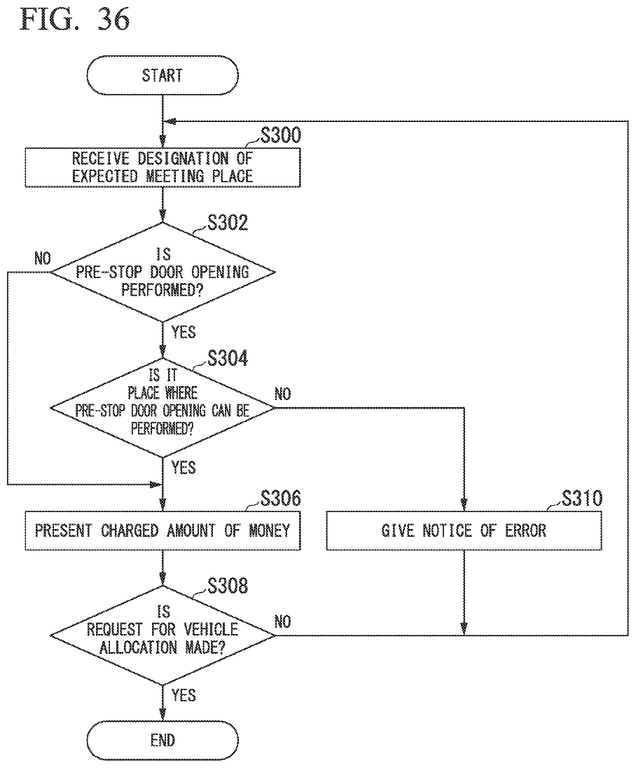

FIG. 36 is a flowchart illustrating another example of a flow of processing for designating an expected meeting place which is performed by the vehicle allocation device A-100. FIG. 36 illustrates another example of processing performed in a case where the vehicle allocation request in step S102 of FIG. 30 is received.

First, the receiver A-130 receives designation of an expected meeting place including designation of pre-stop door opening (step S300). Next, the receiver A-130 determines whether or not designation for performing pre-stop door opening has been received in step S300 (step S302). In a case where pre-stop door opening is performed, the receiver A-130 determines whether or not the expected meeting place received in step S300 is a place where pre-stop door opening can be performed (step S304). In a case where it is determined that the expected meeting place is a place where pre-stop door opening can be performed, the receiver A-130 causes the charging controller A-170 to calculate a charged amount based on the expected meeting place and transmits a reception result including the charged amount to a terminal device T (step S306). Next, the receiver A-130 determines whether or not a request for vehicle allocation to the expected meeting place received in step S200 has been received from the terminal device T (step S308). In a case where the vehicle allocation request has not been received in step S308, the receiver A-130 returns the processing to step S300. In a case where the vehicle allocation request has been received in step S308, the receiver A-130 terminates the processing of the present flowchart.

In a case where it is determined in step S304 that the expected meeting place is not a place where pre-stop door opening can be performed, the receiver A-130 gives an error notification for notifying the user U that a pre-stop door open operation cannot be performed in the expected meeting place (step S310), and returns the processing to step S300. Thus, the description of the processing of the present flowchart will be terminated.

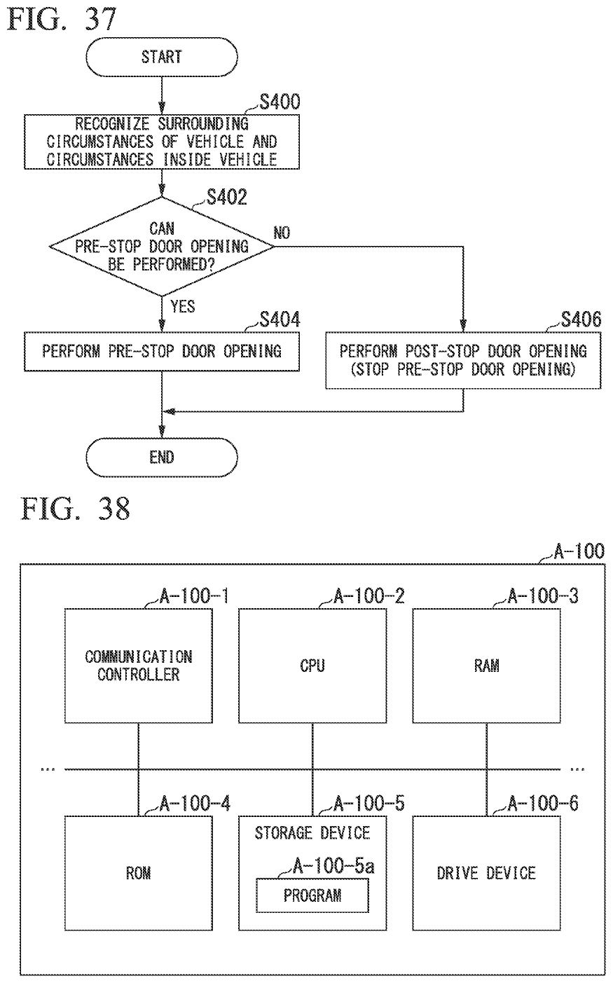

FIG. 37 is a flowchart illustrating an example of a flow of pre-stop door open operation processing performed by the door open and close controller A-14. For example, the processing of the flowchart illustrated in FIG. 37 is performed repeatedly from a timing when the allocated vehicle performing a pre-stop door open operation has approached a meeting place until the allocated vehicle meets a user U in the meeting place.

First, the recognizer A-12 recognizes the surrounding circumstances of the allocated vehicle and circumstances inside the allocated vehicle (step S400). Next, the estimator A-15 estimates whether or not a pre-stop door open operation can be performed (step S402). In a case where it is estimated that a pre-stop door opening can be performed, the door open and close controller A-14 performs pre-stop door opening (step S404). In a case where it is estimated that a pre-stop door opening cannot be performed, the door open and close controller A-14 performs a door open operation after the vehicle is stopped (step S404). Meanwhile, in a case where a pre-stop door open operation has been already started, the door open and close controller A-14 stops the door open operation in step S404. Thus, the description of the processing of the present flowchart is terminated.

In the vehicle allocation system A-1 according to the sixth embodiment, the vehicle allocation controller A-140 directs the vehicle M to an expected meeting place designated by the user U based on a vehicle allocation request received from the user U, the vehicle stopping space determiner A-150 determines whether or not there is a vehicle stopping space for stopping the vehicle M in a case where the vehicle M has approached the expected meeting place, and the proposer A-160 proposes an alternative meeting place to the user in a case where it is determined that there is no vehicle stopping space, whereby it is possible to make the user U and the allocated vehicle meet each other more smoothly.

Further, in the vehicle allocation system A-1 according to the sixth embodiment, in a case where the receiver A-130 has accepted that a pre-stop door open operation for starting to open a door of an allocated vehicle is performed even in a state where the allocated vehicle does not stop completely, the door open and close controller A-14 of the vehicle control device A-10 of the allocated vehicle controls the opening and closing of the door of the allocated vehicle so as to perform the pre-stop door open operation based on an instruction received from a user U in a case where the allocated vehicle approaches a meeting place at a predetermined distance and the allocated vehicle satisfies predetermined door open conditions, and thus it is possible to reduce a period of time until the user U boards the allocated vehicle.

[Hardware Configuration]

FIG. 38 is a diagram illustrating an example of hardware configurations of the management device 200 and the vehicle allocation device A-100 according to the embodiment. FIG. 38 illustrates a hardware configuration of the vehicle allocation device A-100 as an example, but the management device 200 also has a similar configuration. As illustrated in the drawing, various control devices have a configuration in which a communication controller A-100-1, a CPU A-100-2, a RAM A-100-3 used as a working memory, a ROM A-100-4 that stores a boot program and the like, a storage device A-100-5 such as a flash memory or an HDD, a drive device A-100-6, and the like are connected to each other through an internal bus or a dedicated communication line. The communication controller A-100-1 communicates with components other than the vehicle allocation device A-100. The storage device A-100-5 stores a program A-100-5a executed by the CPU A-100-2. The program is developed to the RAM A-100-3 by a direct memory access (DMA) controller (not shown) or the like and executed by the CPU A-100-2. Thereby, a portion or the entirety of the vehicle allocation device A-100 is realized.

Although a mode for carrying out the present invention has been described using the embodiments, the present invention is not limited to such embodiments, and various modifications and substitutions can be added without departing from the scope of the present invention.

For example, in a case where a user U has a large luggage, is carrying an infant, is using a wheelchair or a cane, or is in a poor physical condition, the proposal of an alternative meeting place is not always preferable. For this reason, processing for proposing an alternative meeting place which is performed by the proposer A-160 may be stopped depending on attributes or circumstances of the user U. In this case, for example, a button for designating non-use of the proposal of an alternative meeting place, or the like may be displayed in the image IM1 or the image IM5 displayed when a vehicle allocation request is given.

The above-described embodiments can be expressed as follows.

A system including:
a storage device which stores a program; and
a hardware processor,
wherein the hardware processor is configured to
acquire first notification information for applying for use of a vehicle from a terminal device of a user by executing the program stored in the storage device,
perform securing processing for securing a vehicle to be provided to the user in accordance with the first notification information acquired by a first acquirer, and
perform processing based on a change in details of use of the vehicle in a case where the details of use of the vehicle have been changed after the first acquirer acquires the first notification information.

Although a mode for carrying out the present invention has been described using the embodiments, the present invention is not limited to such embodiments, and various modifications and substitutions can be added without departing from the scope of the present invention.

What is claimed is:

1. A system comprising:
a first acquirer configured to acquire, from a terminal device of a user, first notification information for applying for use of a vehicle;
a first processor configured to perform securing processing for securing a vehicle to be provided to the user, in accordance with the first notification information acquired by the first acquirer; and
a second processor configured to perform processing based on a change in details of use of the vehicle in a case where the details of use of the vehicle have been changed after the first acquirer acquires the first notification information.

2. The system according to claim 1, further comprising:
a second acquirer configured to acquire, from the terminal device of the user, second notification information indicating that the details of the use have been changed,
wherein the second processor executes, as processing according to the change, processing for charging the user a first fee in a case where the second acquirer acquires second notification information in a first period, the first period being set to be a period between a timing at which the first acquirer acquires the first notification information and a timing at which the first processor transmits the securing notification information on the securing processing to the terminal device of the user.

3. The system according to claim 2, wherein the second processor charges the terminal device of the user a second fee higher than the first fee in a case where the second acquirer does not acquire the second notification information in the first period and acquires the second notification information in a second period which starts after the first period and ends when the vehicle secured by the first processor starts to move.

4. The system according to claim 2, wherein the second processor charges the terminal device of the user a third fee higher than the second fee in a case where the second acquirer does not acquire the second notification information in the first period and the second period, and acquires the second notification information in a third period which starts after the second period and ends when the user boards the vehicle.

5. The system according to claim 4, wherein the third fee is lower than an amount of money charged in a case where the user actually uses the vehicle.

6. The system according to claim 2, wherein the first processor performs processing for securing the vehicle after the securing notification information is transmitted to the terminal device.

7. The system according to claim 2, wherein the second processor subtracts the first fee from a deposit provided to the information processing device at least before the first processor performs the securing.

8. The system according to claim 2, wherein the first processor does not perform securing processing for securing a vehicle based on the first notification information transmitted by a terminal device of a user who has been charged a predetermined number of times or more or a predetermined amount of money or more by the second processor.

9. The system according to claim 2,
wherein the first processor determines a first travel route of the vehicle based on the first notification information acquired from a first terminal device of a first user, and corrects the first travel route based on the first notification information acquired from a second terminal device of a second user in a case where the vehicle is traveling on the determined first travel route,
wherein the first period is a period between a timing at which the first processor acquires first notification information of the second terminal device and a timing at which the first processor corrects the first travel route, and
wherein the second processor charges the second terminal device of the second user a fourth fee in a case where the second acquirer acquires the second notification information from the second terminal device in the first period.

10. The system according to claim 9, wherein the second processor charges the terminal device of the user a fifth fee higher than the fourth fee in a case where the second acquirer does not acquire the second notification information in the first period and acquires the second notification information in a second period between a timing at which the first processor corrects the first travel route and a timing at which the vehicle enters the corrected first travel route.

11. The system according to claim 2,
wherein the first processor changes the first period, which is a period until the securing notification information is transmitted, based on an operation state of a vehicle managed by the information processing device to provide a service, and
wherein the second processor determines an amount of the first fee based on a length of the first period.

12. The system according to claim 11, wherein the first processor provides information indicating the first period to the terminal device and transmits the securing notification information to the terminal device in a case where information indicating acceptance of the first period is acquired from the terminal device.

13. The system according to claim 1, further comprising:
a second acquirer configured to acquire information on surrounding circumstances of a vehicle;
a vehicle allocation controller which causes the vehicle to move to an expected meeting place designated by the user based on the first notification information;
a charging controller configured to charge the user a vehicle allocation service charge based on an acquisition result of the first acquirer; and
a vehicle stopping space determiner configured to determine whether or not there is a vehicle stopping space for parking the vehicle in the expected meeting place in a case where the vehicle allocated based on the first notification information has approached the expected meeting place,
wherein the second processor proposes an alternative meeting place, which is different from the expected meeting place, to the user in a case where the vehicle stopping space determiner determines that there is no vehicle stopping space.

14. The system according to claim 13,
wherein the first acquirer receives, from the user, a response including information regarding whether or not to change from the expected meeting place to the alternative meeting place in a case where the second processor proposes the alternative meeting place, and
wherein the charging controller does not charge the user a cancellation charge in a case where the first acquirer has received a response indicating that the alternative meeting place has been rejected and cancelled.

15. The system according to claim 13, wherein the second processor proposes the alternative meeting place to the user and then proposes to the user that a meeting place be set to the expected meeting place again from the alternative meeting place in a case where the second acquirer has acquired information indicating that there is a vehicle stopping space for parking the vehicle in the expected meeting place.

16. The system according to claim 15, wherein the first acquirer receives a response indicating a change to the alternative meeting place, a response indicating that the alternative meeting place is rejected to cancel vehicle allocation, or a response indicating a return to the expected meeting place in a case where the second processor has proposed to the user that a meeting place is set from the alternative meeting place to the expected meeting place, and the charging controller does not charge the user an additional charge in a case where any of the responses has been selected.

17. The system according to claim 13, further comprising a collector configured to collect determination results related to the expected meeting place and the alternative meeting place, which are obtained by the vehicle stopping space determiner,
wherein the charging controller changes a charging rate for the expected meeting place based on an availability trend of vehicle stopping spaces with reference to results collected by the collector.

18. The system according to claim 13,
wherein the second acquirer acquires recognition results of the surrounding circumstances of other vehicles other than the vehicle caused to move to the expected meeting place, and
wherein the vehicle stopping space determiner determines whether or not there is a vehicle stopping space based on the results of recognizing the surrounding circumstances of the other vehicles, in addition to results of recognizing the surrounding circumstances of the vehicle.

19. The system according to claim 13, wherein the vehicle allocation controller causes the vehicle to move to the alternative meeting place in a case where the first acquirer has received, from the user, a response indicating that the expected meeting place is to be changed to the alternative meeting place, and estimates that there is a vehicle stopping space for parking the vehicle in the expected meeting place and causes the vehicle to move to the expected meeting place in a case where the first acquirer has received, from the user, a response indicating that the expected meeting place is not to be changed to the alternative meeting place.

20. The system according to claim 19,
wherein, after the second processor proposes the alternative meeting place, the vehicle stopping space determiner performs processing for determining whether or not there is the vehicle stopping space in the expected meeting place until the vehicle arrives at the expected meeting place or the alternative meeting place, and
wherein the second processor cancels a change to the alternative meeting place and gives such a notification that a meeting place is able to be set to the expected meeting place again in a case where the alternative meeting place has been already proposed and the vehicle stopping space determiner determines that there is the vehicle stopping space in the expected meeting place.

21. A vehicle control device comprising:
a travel controller that controls traveling of an allocated vehicle in response to a vehicle allocation instruction of the system according to claim 13; and
a door open and close controller configured to control opening and closing of a door of the allocated vehicle based on an instruction received from the user,
wherein, in a case where the first acquirer has accepted, from the user, to perform a pre-stop door open operation of starting to open the door even when the allocated vehicle has not completely stopped, the door open and close controller performs control so as to perform the pre-stop door open operation when the allocated vehicle has approached the meeting place within a predetermined distance and the allocated vehicle satisfies predetermined door open conditions.

22. The vehicle control device according to claim 21, wherein the predetermined door open conditions include:
a surrounding environment condition including a condition that the pre-stop door open operation is permitted in the meeting place;
an allocated-vehicle-side condition including a condition that there is no object inside the allocated vehicle, which is likely to fall due to door opening; and
a user-side condition including a condition that an amount of the user's luggage is less than a predetermined amount.

23. The vehicle control device according to claim 21, wherein the door open and close controller stops opening of a door in a case where the predetermined door open conditions are not satisfied.

24. An information processing method, which is executed by a computer, the information processing method comprising:
acquiring, from a terminal device of a user, first notification information for applying for use of a vehicle;
performing securing processing for securing a vehicle to be provided to the user, in accordance with the first notification information acquired by the first acquirer; and
performing processing based on a change in details of use of the vehicle in a case where the details of use of the vehicle have been changed after the first acquirer acquires the first notification information.
